(19) United States
(12) Patent Application Publication
(10) Pub. No.: US 2026/0275114 A1
(43) Pub. Date: Sep. 17, 2026

(54) PHOTOCURABLE COMPOSITION AND USES THEREOF

(71) Applicant: Board of Regents, The University of Texas System, Austin, TX (US)

(72) Inventors: Zachariah A. Page, Austin, TX (US); Connor J. O'Dea, Austin, TX (US); Jussi Isokuortti, Austin, TX (US); Sean T. Roberts, Austin, TX (US)

(21) Appl. No.: 19/203,363

(22) Filed: May 9, 2025

Related U.S. Application Data
(60) Provisional application No. 63/669,366, filed on Jul. 10, 2024.

(51) Int. Cl. C09D 4/00; B33Y 10/00; B33Y 70/00; C08F 20/30; C09D 133/14

(52) U.S. Cl. CPC C09D 4/00; B33Y 70/00; C08F 20/30; C09D 133/14; B33Y 10/00; C08F 2810/20

(57) ABSTRACT

A photosystem based on triplet-triplet annihilation upconversion is capable of efficiently driving a Type I photocuring process at low power density and in the presence of ambient oxygen. A photocurable composition includes particular amounts of a photosensitizer, an annihilator compound, a photoinitiator, and a monomer composition. The photosensitizer is capable of absorbing a first wavelength of light to form a first triplet state, the annihilator compound is capable of accepting triplet energy transfer from the first triplet state of the photosensitizer, and the photoinitiator is capable of absorbing a second wavelength of light emitted from a singlet excited state of the annihilator compound. The photocurable composition can be particularly useful for high resolution 3D printing.

### CROSS REFERENCE TO RELATED APPLICATION

This application claims priority to U.S. Provisional Application No. 63/669,366, filed on Jul. 10, 2024, the contents of which are hereby incorporated by reference in their entirety.

### FEDERAL RESEARCH STATEMENT

This invention was made with government support under Grant No. CHE2155017 awarded by the National Science Foundation. The government has certain rights in the invention.

### BACKGROUND

Light-driven polymerizations have enabled transformative advances in materials chemistry from coatings, adhesives, and lithography used in the fabrication of modern microelectronics to emergent additive manufacturing technologies (e.g., 3D printing) used broadly in the dental and medical industries to create items ranging from teeth alignment devices to surgical tools. V at-based photopolymerizations, wherein rapid (e.g., on the order of seconds) solidification of liquid resin occurs upon exposure to light (i.e., photocuring), have led to some of the highest build rates of any 3D printing technique. Moreover, the precise spatial and temporal control offered by light has resulted in unparalleled print fidelity (i.e., feature resolution).

Several challenges in light-based 3D printing persist. This includes a reliance on high-energy photons (e.g., <400 nanometers (nm), UV) and/or high light exposure intensity (e.g., >100 milliwatts per square centimeter (mW/cm²)), the need for inert printing conditions (e.g., nitrogen (N₂) or argon (Ar) atmosphere), and the high cost of printing components (e.g., pulsed lasers). These issues limit both accessibility, due to high cost, and materials scope, due to photodegradation, phototoxicity, and shallow penetration depth that arises from nonspecific absorption and scattering of short-wavelength UV light.

It would therefore be advantageous to provide new compositions for photocuring that can address the above-described technical limitations. In particular, it would be desirable to provide a composition suitable for an inexpensive, rapid, and high-resolution manufacturing process, such as digital light processing (DLP) 3D printing, with improved cure depth confinement and resin shelf stability.

### SUMMARY

An aspect of the present disclosure is a photocurable composition comprising: 0.0001 to 1 millimoles per liter of the photocurable composition of a photosensitizer capable of absorbing a first wavelength of light to form a first triplet state; 0.01 to 100 millimoles per liter of the photocurable composition of an annihilator compound capable of accepting triplet energy transfer from the first triplet state of the photosensitizer; 0.1 to 500 millimoles per liter of the photocurable composition of a photoinitiator capable of absorbing a second wavelength of light emitted from a singlet excited state of the annihilator compound; and a monomer composition; wherein the second wavelength of light has a wavelength that is less than the first wavelength of light; and wherein the photoinitiator does not absorb the first wavelength of light.

Another aspect is a cured composition derived from the photocurable composition.

Another aspect is a method of providing a cured composition, the method comprising: irradiating the photocurable composition with a first wavelength of light to provide the cured composition, wherein the first wavelength of light is capable of being absorbed by the photosensitizer, and wherein the photoinitiator does not absorb the first wavelength of light.

The above described and other features are exemplified by the following figures and detailed description.

### BRIEF DESCRIPTION OF THE DRAWINGS

The following figures are exemplary embodiments.

FIG. 1 shows photosystem components and photoinitiation mechanisms (top) and energy level schematic showing the mechanisms for photoinitiation (bottom). Processes include photoexcitation, intersystem crossing (ISC), electron transfer (solid hook arrows), and energy transfer (dashed arrows). TET, triplet energy transfer; TTA, triplet-triplet annihilation; [Ox], oxidation; [Red], reduction; R·, radical; M, monomer; Pn, polymer.

FIG. 2 shows time evolution of upconverted DPA fluorescence (cyan) and platinum octaethylporphyrin (PtOEP) phosphorescence (maroon) in 2-phenoxyethyl acrylate monomer. Photoluminescence was measured at 436 and 645 nm at low and high excitation intensity (Iₑₓ=50 and 1000 mW/cm²).

FIG. 3 shows upconverted diphenylanthracene (DPA) fluorescence in 2-phenoxyethyl acetate as a function of excitation intensity to quantify the threshold intensity (Iₜₕ) using a double-logarithmic plot.

FIG. 4 shows the absorption spectrum of bisacylphosphine oxide (BAPO) (purple-shaded) overlaps with the emission spectrum of DPA (cyan dashed). Likewise, the absorption spectrum of PtOEP (red-shaded) overlaps with the emission spectrum of the 525 nm light emitting diode (LED) used to excite the triplet-triplet annihilation upconversion (TTA-UC) system. Note, the LED has been passed through a 525×25 nm bandpass filter to narrow its spectrum.

FIG. 5 shows FTIR-ATR, plotting C═C conversion versus time of the standard resin ([PtOEP]=600 micromolar (μM); [DPA]=6 millimolar (mM); [BAPO]=30 mM) and its ½ dilution. Resins were tested under inert (solid) and ambient (dashed) conditions and high intensity (50 mW/cm², red) or low intensity (5 mW/cm², blue) 525 nm light irradiation.

FIG. 6 shows FTIR-ATR intensity sweeps of the TTA-UC resin in 2-phenoxyethyl acrylate (PhOEA) under an argon atmosphere with the optimized photosystem ([PtOEP]=0.6 mM; [DPA]=6 mM; [BAPO]=30 mM). The 525 nm LED was turned on at 10 seconds.

FIG. 7 shows a plot of initial photopolymerization rate versus light intensity for the Type I photosystem driven by TTA-UC (triangles), Type I photosystem driven by direct UV/violet excitation of BAPO (diamonds), and the Type II photosystem (circles). The number near each linear best-fit curve indicates its slope.

FIG. 8 shows normalized time to reach 50% conversion (t₅₀) of the Type II and TTA-UC resins over 45 days.

FIG. 9 shows FTIR-ATR intensity sweeps using the 525 nm LED turned on at 10 seconds for photocurable resins according to an aspect of the disclosure.

FIG. 10 shows a plot of initial photopolymerization rate (millimolar per second (mM/s)) vs light intensity (mW/cm²) for the Type I photosystem driven by TTA-UC. The number near each linear best fit curve indicates its slope.

FIG. 11 shows cure depth as a function of light dosage (E₀) for the three resins. Critical exposure (E_{c}) and depth of penetration (Dₚ) values were determined from the semilog plot of C_{d} vs E₀.

FIG. 12 shows digital light processing (DLP) 3D printing under an ambient oxygen atmosphere of a Rook and a Benchy.

### DETAILED DESCRIPTION

In recent years, various strategies have been developed to address the above-described limitations of UV photocuring. This includes photocatalysts that directly operate using visible and near-infrared light as well as more sophisticated multiphoton excitation modes for catalysts that require higher energy, such as two-photon absorption, two-step absorption, and photon upconversion. Notably, the latter three techniques have a quadratic relationship between incident light intensity and photocuring rate. This superlinear relationship stems from the requisite combination of multiple photons to generate the radical species that initiate polymerization. In turn, photocuring can be accomplished within a focal point of light, which has allowed production of subdiffraction-limited features (roughly λ/2) and voxel-by-voxel (i.e., volumetric) 3D printing. However, 3D printing in this manner has required scanning a high-intensity, tightly focused laser beam (>1 W/cm²), which requires expensive instrumentation, and results in slow fabrication (e.g., <10⁻³ cubic millimeters per second (mm³/s)) of objects confined to small volumes.

As an alternative 3D printing strategy to multiphoton laser-based methods, digital light processing (DLP) offers a low-cost route to the rapid fabrication (e.g., on the order of 1 mm³/s) of large-volume objects. DLP 3D printing operates in a layer-by-layer fashion, where each exposure represents a 2D projection (i.e., slice) of the 3D object. Typical projection intensities in commercial DLP 3D printers range from about 5 to 50 mW/cm². However, higher-intensity light engines (e.g., >100 mW/cm²) represent an active area of research given the potential for higher production speeds that offset the additional energetic costs. Although the feature resolution of DLP 3D printing at present does not match that of multiphoton techniques, it can provide fidelity on the 10-100 micrometer (μm) scale with proper optimization. Specifically, feature optimization is accomplished by mitigating lateral (x, y) and vertical (z) overcure (i.e., solidification that occurs outside the defined irradiation zones). However, speed and resolution are often at odds within one-photon systems given that high light sensitivity is required to achieve rapid photocuring. Thus, scattered light and vertically transmitted light beyond a single layer often result in overcure, reducing feature fidelity.

Relative to standard DLP 3D printing, a multiphoton method has the potential to improve resolution, as the scattered and through-slice transmitted light lacks the intensity to induce curing given the superlinear dependence of the polymerization rate on the excitation intensity. Of the aforementioned multiphoton excitation pathways, triplet-triplet annihilation upconversion (TTA-UC) stands out due to its capability to operate efficiently (>10% quantum yield) under DLP-relevant, low-intensity excitation (<50 mW/cm²). TTA-UC-driven polymerizations have yet to be applied to DLP 3D printing. TTA-UC 3D printing has remained limited to high-intensity excitation (>10 W/cm²) and stringent oxygen-free conditions.

The present inventors have discovered that upconversion-based 3D printing can be made more accessible by constructing a TTA-UC-driven photopolymerization system that achieves the desired superlinear (~quadratic) intensity dependence (and hence high spatial resolution) upon exposure to low-intensity (<10 mW/cm²) visible light from an inexpensive LED source under ambient conditions. To accomplish this objective, the inventors have developed a TTA-UC to Type I photoinitiation system capable of providing short gelation times (<60 seconds (s)) with low-intensity green or red light exposure in the presence of ambient oxygen, which is competitive with Type II photosystems. With this resin formulation, the utility of TTA-UC in DLP-based 3D printing to rapidly produce high-resolution objects (~100 μm scale features) has been demonstrated, showcasing the potential for TTA-UC systems to provide a commercially viable platform for inexpensive light-based manufacturing. A significant improvement is therefore provided by the present disclosure.

Accordingly, an aspect of the present disclosure is a photocurable composition. The photocurable composition comprises particular amounts of a photosensitizer, an annihilator compound, a photoinitiator, and a monomer composition.

The photosensitizer is capable of absorbing a first wavelength of light to form a first triplet state. Exemplary photosensitizers can include metal-containing compounds such as metal porphyrins, metal phthalocyanines, and the like. In an aspect, the photosensitizer comprises a metal porphyrin, for example having the structure

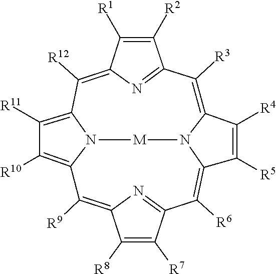

wherein M is a metal comprising platinum, palladium, zinc, silicon, or manganese, and each of R¹ to R¹² are independently hydrogen, a substituted or unsubstituted alkyl, a substituted or unsubstituted aryl, or a substituted or unsubstituted alkenyl.

In an aspect, the photosensitizer can comprise a platinum-containing porphyrin or phthalocyanine, for example platinum octaethylporphyrin, platinum meso-tetraphenyl tetrabenzoporphine, platinum meso-tetraphenylporphine, platinum tetraphenyl tetranaphthoporphyrin, or platinum phthalocyanine. In an aspect, the photosensitizer can comprise a palladium-containing porphyrin or phthalocyanine, for example a palladium meso-tetraphenyl tetrabenzoporphine, a palladium octaethylporphyrin, palladium meso-tetraphenylporphine, palladium tetraphenyl tetranaphthoporphyrin, palladium phthalocyanine, palladium octabutoxy phthalocyanine, or palladium octapentyl phthalocyanine. In an aspect, the photosensitizer can comprise a zinc-containing porphyrin or phthalocyanine, for example a zinc octaethylporphyrin, zinc meso-tetraphenyl tetrabenzoporphine, zinc meso-tetraphenylporphine, zinc phthalocyanine, zinc octabutoxy phthalocyanine, zinc octapentyl phthalocyanine. In an aspect, the photosensitizer can comprise a silicon-containing phthalocyanine, for example a silicon octabutoxy phthalocyanine, silicon octapentyl phthalocyanine. Other photosensitizers are also contemplated by the present disclosure, for example including but not limited to 3,3′-carbonylbis(7-diethylaminocoumarin) (CBDAC), 1,2,3,5-tetrakis(carbazol-9-yl)-4,6-dicyanobenzene (4CzlPN), 3,4,5,6-tetrakis(carbazol-9-yl)-1,2-dicyanobenzene (4CzPN), or (4,4-difluoro-4-bora-3a,4a-diaza-s-indacene) (BODIPY) and derivatives thereof. Combinations of the foregoing may also be used.

In an aspect, the photosensitizer is capable of absorbing light (i.e., the first wavelength of light, also referred to as an excitation wavelength of the photosensitizer) in the range of 400 to 1000 nm. Within this range, the excitation wavelength can be at least 425 nm, or at least 450 nm, or at least 475 nm, or at least 500 nm, or at least 525 nm, or at least 550 nm, or at least 600 nm, or at least 625 nm. Also within this range, the excitation wavelength can be no more than 900 nm, or no more than 800 nm, or no more than 750 nm, or no more than 700 nm, or no more than 675 nm, or no more than 650 nm, or no more than 625 nm, or no more than 600 nm, or no more than 575 nm, or no more than 550 nm, or no more than 525 nm. Combinations of any of these are possible. For example, the excitation wavelength of the photosensitizer can be 400 to 800 nm, or 450 to 750 nm, or 500 to 700 nm, or 500 to 650 nm, or 510 to 635 nm.

The concentration of the photosensitizer can be expressed in terms of a molar concentration (i.e., moles per liter (M) of the photocurable composition of millimoles per liter (mM) of the photocurable composition). The photosensitizer can generally be present at any suitable amount or concentration. In an aspect, it may be preferable for the photosensitizer to be present in the photocurable composition in a concentration of 0.0001 to 1 millimoles per liter of the photocurable composition. Within this range, the photosensitizer can be present in a concentration of at least 0.0005 millimoles per liter, or at least 0.001 millimoles per liter, or at least 0.005 millimoles per liter, or at least 0.01 millimoles per liter, or at least 0.1 millimoles per liter, or at least 0.02 millimoles per liter, or at least 0.04 millimoles per liter of the photocurable composition. Also within this range, the photosensitizer can be present in a concentration of at most 0.9 millimoles per liter, or at most 0.85 millimoles per liter, or at most 0.8 millimoles per liter, or at most 0.5 millimoles per liter, or at most 0.1 millimoles per liter, or at most 0.06 millimoles per liter, or at most 0.05 millimoles per liter of the photocurable composition. For example, the photosensitizer can be present in a concentration of 0.0001 to 0.1 millimoles per liter, or 0.001 to 0.1 millimoles per liter, or 0.01 to 1 millimoles per liter of the photocurable composition. In an aspect, the photosensitizer can be present in a concentration of 0.4 to 0.8 millimoles per liter of the photocurable composition. In an aspect, the photosensitizer can be present in a concentration of 0.04 to 0.06 millimoles per liter of the photocurable composition. Though the aforementioned concentrations may be preferred, other concentrations are also contemplated by the present disclosure. For example, the photosensitizer can be present in a concentration of at least 0.0001 millimoles per liter, at least 0.0005 millimoles per liter, or at least 0.001 millimoles per liter, or at least 0.005 millimoles per liter, or at least 0.01 millimoles per liter, or at least 0.1 millimoles per liter, or at least 0.5 millimoles per liter, or at least 1 millimole per liter, or at least 10 millimoles per liter, or at least 100 millimoles per liter, or at least 500 millimoles per liter, or at least 1 mole per liter, or at least 5 moles per liter. In an aspect, the photosensitizer can be present in a concentration of no more than 10 moles per liter, or no more than 5 moles per liter, or no more than 1 mole per liter, or no more than 500 millimoles per liter, or no more than 100 millimoles per liter, or no more than 50 millimoles per liter, or no more than 10 millimoles per liter, or no more than 1 millimole per liter, or no more than 0.5 millimoles per liter, or no more than 0.1 millimoles per liter, or no more than 0.01 millimoles per liter.

The photocurable composition further comprises an annihilator compound. The annihilator compound is capable of accepting triplet energy transfer from the first triplet state of the photosensitizer. The annihilator compound has a lower triplet energy relative to the photosensitizer to enable triplet energy transfer between the compounds. When two annihilator compounds each in their triplet excited state collide, triplet-triplet annihilation occurs, yielding one ground-state annihilator, and one annihilator compound in a singlet excited state. The excited spin-singlet annihilator compound can then emit a high energy photon (e.g., light that is blue shifted relative to the wavelength of light used to excite the photosensitizer).

Suitable annihilator compounds can be, for example, fluorophores which can include one or more fused benzene rings and/or one or more conjugated double bonds. Exemplary annihilator compounds can include, for example, a substituted or unsubstituted anthracene, a substituted or unsubstituted naphthalene, a substituted or unsubstituted pentacene, a substituted or unsubstituted pyrene, a substituted or unsubstituted perylene, a substituted or unsubstituted tetracene, a substituted or unsubstituted rubrene, or a combination thereof. In an aspect, the annihilator compound can preferably comprise a substituted or unsubstituted anthracene, for example a diphenyl anthracene, bis(phenylethynyl)anthracene, 9-phenyl-10-(phenylethynyl)anthracene, or a diethynyl anthracene. In an aspect, the annihilator compound can comprise a perylene such as unsubstituted perylene or tetra-tert-butyl perylene. In an aspect, the annihilator compound can comprise a pyrene, such as a triisopropylsilyl substituted pyrene or a triethylsilyl substituted pyrene, or 2,7-di(tertbutyl)pyrene. Triisopropylsilyl substituted naphthalene and tetracene, and 2,5-diphenyloxazole are also contemplated as annihilator compounds.

In an aspect, the annihilator compound has an emission wavelength (i.e., the second wavelength) of light in the range of 300 to 700 nm, provided that the emission wavelength is less than (i.e., blue shifted relative to) the first wavelength of light. Within this range, the emission wavelength can be at least 350 nm, or at least 375 nm, or at least 400 nm, or at least 410 nm, or at least 420 nm, or at least 450 nm. Also within this range, the emission wavelength can be no more than 600 nm, or no more than 500 nm, or no more than 480 nm, or no more than 475 nm, or no more than 460 nm, or no more than 440 nm. Combinations of any of these are possible. For example, the emission wavelength can be 375 to 500 nm, or 400 to 500 nm, or 410 to 480 nm, or 410 to 475 nm, or 410 to 460 nm.

The concentration of the annihilator compound can be expressed in terms of a molar concentration (i.e., moles per liter (M) of the photocurable composition of millimoles per liter (mM) of the photocurable composition). The annihilator compound can generally be present at any suitable amount or concentration. The annihilator compound can be present in the photocurable composition in a concentration of 0.01 to 100 millimoles per liter of the photocurable composition. Within this range, the annihilator compound can be present in a concentration of at least 0.05 millimoles per liter, or at least 0.1 millimoles per liter, or at least 0.5 millimoles per liter, or at least 1 millimoles per liter, or at least 4 millimoles per liter of the photocurable composition. Also within this range, the annihilator compound can be present in a concentration of at most 75 millimoles per liter, or at most 50 millimoles per liter, or at most 25 millimoles per liter, or at most 15 millimoles per liter, or at most 10 millimoles per liter, or at most 5 millimoles per liter, or at most 1 millimole per liter, or at most 0.5 millimoles per liter, or at most 0.1 millimoles per liter of the photocurable composition. For example, the annihilator compound can be present in a concentration of 0.01 to 10 millimoles per liter, or 1 to 10 millimoles per liter. In an aspect, the annihilator compound can be present in a concentration of 4 to 8 millimoles per liter. In an aspect, the annihilator compound can be present in a concentration of 0.4 to 0.8 millimoles per liter. Though the aforementioned concentrations may be preferred, other concentrations are also contemplated by the present disclosure. For example, the annihilator compound can be present in a concentration of at least 0.01 millimoles per liter, at least 0.05 millimoles per liter, or at least 0.1 millimoles per liter, or at least 0.5 millimoles per liter, or at least 1 millimole per liter, or at least 10 millimoles per liter, or at least 100 millimoles per liter, or at least 500 millimoles per liter, or at least 1 mole per liter, or at least 5 moles per liter. In an aspect, the annihilator compound can be present in a concentration of no more than 10 moles per liter, or no more than 5 moles per liter, or no more than 1 mole per liter, or no more than 500 millimoles per liter, or no more than 100 millimoles per liter, or no more than 50 millimoles per liter, or no more than 10 millimoles per liter, or no more than 1 millimoles per liter, or no more than 0.5 millimoles per liter, or no more than 0.1 millimoles per liter.

The photocurable composition further comprises a photoinitiator. The photoinitiator is capable of absorbing a second wavelength of light emitted from a singlet excited state of the annihilator compound. Thus the photoinitiator has an absorption that at least partially overlaps with the upconversion emission of the annihilator compound. The photoinitiator does not absorb the first wavelength of light, and the second wavelength of light is less than the first wavelength of light used to activate the photosensitizer (i.e., the second wavelength if light is blue-shifted relative to the first wavelength of light). In addition to the emission reabsorption mechanism, the photoinitiator can also be activated by energy transfer from the ground state annihilator compound generated from the triplet-triplet annihilation discussed above. In either case, the excited photoinitiator will cleave homolytically to yield two reactive moieties capable of initiating polymerization.

In an aspect, the photoinitiator can have an absorption in the range of 350 to 600 nm. Within this range, the photoinitiator can have an absorption that is at least 360 nm, or at least 375 nm, or at least 385 nm, or at least 400 nm. Also within this range, the photoinitiator can have an absorption that is no more than 500 nm, or no more than 450 nm, or no more than 425 nm, or no more than 415 nm, or no more than 405 nm, or no more than 400 nm. Combinations of any of these are possible. For example, the absorption of the photoinitiator can be 360 to 500 nm, or 360 to 450 nm, or 360 to 425 nm, or 360 to 415 nm, or 360 to 405 nm.

The photoinitiator can generally be any Type I photoinitiator. A Type I photoinitiator refers to a compound that undergoes unimolecular photolysis upon exposure to light. Type I photoinitiators can include photoacid generators, photobase generators, and initiators that form free radicals upon exposure to light. The reactive moiety that is generated by the homolytic cleavage of the photoinitiator will depend on the identity of the photoinitiator.

In a specific aspect, the photoinitiator forms free radicals upon absorption of the second wavelength of light. Any suitable radical photoinitiator can be used and can be selected by the skilled person based on the requirements of the particular system and guided by the present disclosure. Exemplary radical photoinitiators can include, but are not limited to bisacylphosphine oxides (e.g., phenylbis(2,4,6-trimethylbenzoyl)phosphine oxide), or dialkyl germanium (e.g., bis(4-methoxybenzoyl)diethylgermanium), photoinitiators comprising titanocene derivatives, available under the tradename IRGACURE, available from Ciba Specialty Chemicals, isopropylthioxanthone, benzophenone, 2,2-azobisisobutyronitrile (AIBN), camphorquinone, diphenyltrimethylbenzoylphosphine oxide (TPO), (1-hydroxycyclohexylphenylketone) (HCP), bis(2,6-difluoro-3-(1-hydropyrrolo-1-yl)phenyl) titanocene, and the like. Also contemplated are compounds of the structure

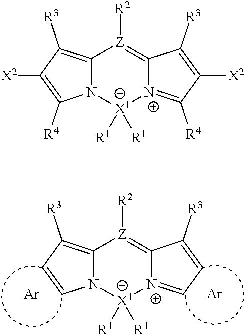

wherein in the foregoing Formulas, X¹ is boron (B) or gallium (Ga); X² is independently at each occurrence hydrogen, chlorine (Cl), bromine (Br), or iodine (I); Z is carbon or nitrogen; R¹ is independently at each occurrence a substituted or unsubstituted C₁₋₆ alkyl group optionally substituted with one or more in-chain or pendent heteroatoms selected from the group consisting of oxygen and sulfur, optionally wherein each occurrence of R¹ (i.e., on a single X¹ moiety) can combine to form a cycloalkyl group; R² is a substituted or unsubstituted C₁₋₆ alkyl group or a substituted or unsubstituted C₆₋₂₀ aryl group; R³ is independently at each occurrence hydrogen, a substituted or unsubstituted C₁₋₆ alkyl group, or a substituted or unsubstituted C₆₋₂₀ aryl group; R⁴ is independently at each occurrence hydrogen, a substituted or unsubstituted C₁₋₆ alkyl group, or a substituted or unsubstituted C₆₋₂₀ aryl group; and Ar is a substituted or unsubstituted fused aryl group optionally substituted with one or more in-chain or pendent heteroatoms selected from the group consisting of oxygen, nitrogen, and sulfur. Such compounds are further described in International Application No. PCT/US2024/033196, the contents of which are hereby incorporated by reference in their entirety.

In a specific aspect, the photoinitiator comprises a bisacylaphosphine oxide (e.g., phenylbis(2,4,6-trimethylbenzoyl)phosphine oxide), or a dialkyl germanium (e.g., bis(4-methoxybenzoyl)diethylgermanium).

In an aspect, the photoinitiator can be a photoacid generator. As used herein, a “photoacid generator” refers to a polymerization initiator that can generate a cationic species when induced by light (e.g., infrared light, visible light, ultraviolet light, far-ultraviolet light, an X-ray, or a charged particle beam, such as an electron beam). Photoacid generators can therefore generate a cationic species in a chemical reaction caused by photoirradiation and initiate cationic polymerization. In an aspect, the photoacid generator may generate a Bronsted acid or a Lewis acid upon irradiation with light. In an aspect, the photoacid generator can be a triarylsulfonium salt, an aryldiazonium salt, a diaryliodonium salt, a dialkylphenacylsulfonium salt, or a sulfonic ester compound. Exemplary photoacid generators can include, but are not limited to bis[4-(diphenylsulfonio)phenyl]sulfide bis(hexafluoroantimonate), triphenylsulfonium hexafluoroantimonate, tris(4-methoxyphenyl)sulfonium hexafluorophosphate, diphenyl-4-thiophenoxyphenylsulfonium hexafluoroantimonate, diphenyl-4-thiophenoxyphenylsulfonium hexafluorophosphate, 4,4′-bis(diphenylsulfonio)phenyl sulfide-bis-hexafluoroantimonate, 4,4′-bis[di(β-hydroxyethoxy)phenylsulfonio]phenyl sulfide-bis-hexafluoroantimonate, 4,4′-bis[di(β-hydroxyethoxy)phenylsulfonio]phenyl sulfide-bis-hexafluorophosphate, 4-[4′-(benzoyl)phenylthio]phenyl-di-(4-fluorophenyl)sulfonium hexafluoroantimonate, and 4-[4′-(benzoyl)phenylthio]phenyl-di-(4-fluorophenyl)sulfonium hexafluorophosphate. Combinations of photoacid generators can also be used.

In an aspect, the photoinitiator can be a photobase generator. As used herein, a “photobase generator” refers to a polymerization initiator that can generate an anionic species (e.g., an organic base) when induced by light (e.g., infrared light, visible light, ultraviolet light, far-ultraviolet light, an X-ray, or a charged particle beam, such as an electron beam). Photobase generators can therefore generate an anionic species in a chemical reaction caused by photoirradiation and initiate anionic polymerization. In an aspect, a photobase generator capable of generating an amine upon exposure to light can be used, and include, for example, an ortho-nitrobenzyl carbamate compound, an α,α-dimethyl-3,5-dimethoxybenzyl carbamate compound, an acyloxyimino compound and the like.

Specific examples of the ortho-nitrobenzyl carbamate compound include N-(2-nitrobenzyloxy)carbonyl-N-methylamine, N-(2-nitrobenzyloxy)carbonyl-N-n-propylamine, N-(2-nitrobenzyloxy)carbonyl-N-n-hexylamine, N-(2-nitrobenzyloxy)carbonyl-N-cyclohexylamine, N-(2-nitrobenzyloxy)carbonylaniline, N-(2-nitrobenzyloxy)carbonylpiperidine, N,N′-bis[(2-nitrobenzyloxy)carbonyl]-1,6-hexamethylenediamine, N,N′-bis[(2-nitrobenzyloxy)carbonyl]-1,4-phenylenediamine, N,N′-bis[(2-nitrobenzyloxy)carbonyl]-2,4-tolylenediamine, N,N′-bis[(2-nitrobenzyloxy)carbonyl]-4,4′-diaminodiphenylmethane, N,N′-bis[(2-nitrobenzyloxy)carbonyl]piperazine, N-(2,6-dinitrobenzyloxy)carbonyl-N-methylamine, N-(2,6-dinitrobenzyloxy)carbonyl-N-n-propylamine, N-(2,6-dinitrobenzyloxy)carbonyl-N-n-hexylamine, N-(2,6-dinitrobenzyloxy)carbonyl-N-cyclohexylamine, N-(2,6-dinitrobenzyloxy)carbonylaniline, N-(2,6-dinitrobenzyloxy)carbonylpiperidine, N,N′-bis[(2,6-dinitrobenzyloxy)carbonyl]-1,6-hexamethylenediamine, N,N′-bis[(2,6-dinitrobenzyloxy)carbonyl]-1,4-phenylenediamine, N,N′-bis[(2,6-dinitrobenzyloxy)carbonyl]-2,4-tolylenediamine, N,N′-bis[(2,6-dinitrobenzyloxy)carbonyl]-4,4-diaminodiphenylmethane, N,N′-bis[(2,6-dinitrobenzyloxy)carbonyl]piperazine and the like.

Specific examples of the α,α-dimethyl-3,5-dimethoxybenzyl carbamate compound include N-(α,α-dimethyl-3,5-dimethoxybenzyloxy)carbonyl-N-methylamine, N-(α,α-dimethyl-3,5-dimethoxybenzyloxy)carbonyl-N-n-propylamine, N-(α,α-dimethyl-3,5-dimethoxybenzyloxy)carbonyl-N-n-hexylamine, N-(α,α-dimethyl-3,5-dimethoxybenzyloxy)carbonyl-N-cyclohexylamine, N-(α,α-dimethyl-3,5-dimethoxybenzyloxy)carbonylaniline, N-(α,α-dimethyl-3,5-dimethoxybenzyloxy)carbonylpiperidine, N,N′-bis[(α,α-di methyl-3,5-dimethoxybenzyloxy)carbonyl]-1,6-hexamethylenediamine, N,N′-bis[(α,α-dimethyl-3,5-dimethoxybenzyloxy)carbonyl]-1,4-phenylenediamine, N,N′-bis[(α,α-dimethyl-3,5-dimethoxybenzyloxy)carbonyl]-2,4-tolylenediamine, N,N′-bis[(α,α-dimethyl-3,5-dimethoxybenzyloxy)carbonyl]-4,4′-diaminodiphenylmethane, N,N′-bis[(α,α-dimethyl-3,5-dimethoxybenzyloxy)carbonyl]piperazine and the like.

Specific examples of the acyloxyimino compound include acetophenone-O-propanoyl oxime, benzophenone-O-propanoyl oxime, acetone-O-propanoyl oxime, acetophenone-O-butanoyl oxime, benzophenone-O-butanoyl oxime, acetone-O-butanoyl oxime, bis(acetophenone)-O,O′-hexane-1,6-dioyl oxime, bis(benzophenone)-O,O′-hexane-1,6-dioyl oxime, bis(acetone)-O,O′-hexane-1,6-dioyl oxime, acetophenone-O-acryloyl oxime, benzophenone-O-acryloyl oxime, acetone-O-acryloyl oxime and the like.

In an aspect, the photobase can be an onium salt, for example as described in co-pending International Application No. PCT/US2025/017122, filed on Feb. 25, 2025, the contents of which are hereby incorporated by reference in its entirety.

The concentration of the photoinitiator can be expressed in terms of a molar concentration (i.e., moles per liter (M) of the photocurable composition of millimoles per liter (mM) of the photocurable composition). The photoinitiator can generally be present at any suitable amount or concentration. The photoinitiator can be present in the photocurable composition in a concentration of 0.1 to 500 millimoles per liter of the photocurable composition. Within this range, the photoinitiator can be present in a concentration of at least 0.5 millimoles per liter, or at least 1 millimole per liter, or at least 2 millimoles per liter, or at least 5 millimoles per liter of the photocurable composition. Also within this range, the photoinitiator can be present in a concentration of at most 400 millimoles per liter, or at most 300 millimoles per liter, or at most 200 millimoles per liter, or at most 100 millimoles per liter, or at most 50 millimoles per liter, or at most 40 millimoles per liter, or at most 30 millimoles per liter, or at most 25 millimoles per liter, or at most 20 millimoles per liter, or at most 15 millimoles per liter, or at most 10 millimoles per liter of the photocurable composition. For example, in an aspect, the photoinitiator can be present in a concentration of 1 to 10 millimoles per liter, or 4 to 8 millimoles per liter, or 5 to 15 millimoles per liter. Though the aforementioned concentrations may be preferred, other concentrations are also contemplated by the present disclosure. For example, the photoinitiator can be present in a concentration of at least 0.01 millimoles per liter, at least 0.05 millimoles per liter, or at least 0.1 millimoles per liter, or at least 0.5 millimoles per liter, or at least 1 millimole per liter, or at least 10 millimoles per liter, or at least 100 millimoles per liter, or at least 500 millimoles per liter, or at least 1 mole per liter, or at least 5 moles per liter. In an aspect, the photoinitiator can be present in a concentration of no more than 10 moles per liter, or no more than 5 moles per liter, or no more than 1 mole per liter, or no more than 500 millimoles per liter, or no more than 100 millimoles per liter, or no more than 50 millimoles per liter, or no more than 10 millimoles per liter, or no more than 1 millimoles per liter, or no more than 0.5 millimoles per liter, or no more than 0.1 millimoles per liter.

In an aspect, the photosensitizer, the annihilator compound, and the photoinitiator can be present in a molar ratio of photosensitizer:annihilator compound:photoinitiator of 1:10:10 to 1:1,000:10,000. The molar ratio of photosensitizer:annihilator compound can be, for example 1:10 to 1:1,000, or 1:10 to 1:500, or 1:10 to 1:250, or 1:10 to 1:200, or 1:10 to 1:100, or 1:10 to 1:50, or 1:10 to 1:20. The molar ratio of photosensitizer:photoinitiator can be, for example, 1:10 to 1:10,000, or 1:10 to 1:1,000, or 1:10 to 1:500, or 1:10 to 1:100, or 1:10 to 1:50. In a specific aspect, the photosensitizer, the annihilator compound, and the photoinitiator can be present in a molar ratio of photosensitizer:annihilator compound:photoinitiator of 1:10:10 to 1:50:100, for example 1:10:50.

In addition to the photosensitizer, the annihilator compound, and the photoinitiator, the photocurable composition can optionally further comprise an oxygen scavenger. When present, the oxygen scavenger can comprise a phosphine, a thiol, an alkene, or a combination thereof, and is chemically (i.e., compositionally or structurally) distinct from the annihilator compound. Exemplary oxygen scavengers can include, but are not limited to, hydrogen donors (e.g., thiols, amine, hydrogen phosphites, silanes, stannanes, benzaldehydes); n-vinyl amides; reducing agents (e.g., phosphines, phosphites, sulphites, borane-amine complexes); singlet oxygen scavengers (e.g., diphenyl furans, anthracenes); and combinations thereof.

In an aspect, the oxygen scavenger can comprise a thiol, an amine, a hydrogen phosphite, a silane, a stannane, a benzaldehyde, or a combination thereof. In an aspect, the oxygen scavenger can comprise a hydrogen donor comprising methyl diethanolamine (MDEA); 1,4-diazabicyclo[2.2.2]octane (DABCO); tribenzylamine; trimethylolpropane tris(3-mercaptopropionate) (TMPMP); pentaerythritol tetrakis(3-mercaptopropionate) (PETMP); dioleyl hydrogen phosphite; tris(trimethylsilyl)silane; tributyltin hydride; 4-anisaldehyde; or a combination thereof. In an aspect, the oxygen scavenger can comprise an N-vinyl amide comprising n-vinylpyrrolidone; n-methyl-2-pyrrolidone; or a combination thereof. In an aspect, the oxygen scavenger can comprise a reducing agent comprising triphenyl phosphine (PPh₃); trioctyl phosphine; triphenyl phosphite; tetraphenyldipropyleneglycoldiphosphite; poly(dipropyleneglycol)phenylphosphite; alkyl (C₁₂₋₁₅) bisphenol A phosphite; tris(tridecyl)phosphite; 3,9-bis(octadecyloxy)-2,4,8,10-tetraoxa-3,9-diphosphaspiro[5.5]undecane; ethylene sulphite; dimethylamine-borane complex; or a combination thereof. In an aspect, the oxygen scavenger can comprise a singlet oxygen scavenger comprising 2,5-diphenyl furan; 9,10-dibutyl anthracene; or a combination thereof. In an aspect, the oxygen scavenger can comprise a thiol, for example a multifunctional thiol (e.g., a dithiol, a trithiol, a tetrathiol, or a combination thereof). In an aspect, the oxygen scavenger comprises pentaerythritol tetrakis(3-mercaptopropionate) (PETMP); benzene-1,4-dithiol; trithiocyanuric acid; 1,3,4-thiadiazole-2,5-dithiol; 4,4′-thiobisbenzenethiol; triphenylphosphine (PPh₃); 1,3-diphenylisobenzofuran (DPBF); (2,2,6,6-1,4-dithiothreitol (DTT); ascorbic acid (AA); or a combination thereof.

When present, the concentration of the oxygen scavenger can be expressed in terms of a molar concentration (i.e., moles per liter (M) of the photocurable composition of millimoles per liter (mM) of the photocurable composition). The oxygen scavenger can generally be present at any suitable amount or concentration. In an aspect, the oxygen scavenger can be included in the photocurable composition in a concentration of 1 to 100 millimoles per liter of the photocurable composition. Within this range, the oxygen scavenger can be included in the photocurable composition in a concentration of at least 2 millimoles per liter, or at least 5 millimoles per liter of the photocurable composition. Also within this range, the oxygen scavenger can be included in the photocurable composition in a concentration of at most 50 millimoles per liter, or at most 40 millimoles per liter, or at most 30 millimoles per liter, or at most 25 millimoles per liter, or at most 20 millimoles per liter, or at most 15 millimoles per liter, or at most 12 millimoles per liter of the photocurable composition. In a specific aspect, when present, the oxygen scavenger can be included in the photocurable composition in a concentration of 1 to 25 millimoles per liter, or 1 to 20 millimoles per liter, or 5 to 15 millimoles per liter. Though the aforementioned concentrations may be preferred, other concentrations are also contemplated by the present disclosure. For example, the oxygen scavenger can be present in a concentration of at least 0.1 millimoles per liter, or at least 0.5 millimoles per liter, or at least 1 millimole per liter, or at least 10 millimoles per liter, or at least 100 millimoles per liter, or at least 500 millimoles per liter, or at least 1 mole per liter, or at least 5 moles per liter. In an aspect, the oxygen scavenger can be present in a concentration of no more than 10 moles per liter, or no more than 5 moles per liter, or no more than 1 mole per liter, or no more than 500 millimoles per liter, or no more than 100 millimoles per liter, or no more than 50 millimoles per liter, or no more than 10 millimoles per liter, or no more than 1 millimoles per liter, or no more than 0.5 millimoles per liter, or no more than 0.1 millimoles per liter. In some aspects, an additional oxygen scavenger is omitted or excluded from the photocurable composition.

In an aspect, the photosensitizer, the annihilator compound, the photoinitiator, and the oxygen scavenger can be present in a molar ratio of photosensitizer:annihilator compound:photoinitiator:oxygen scavenger of 1:10:1:10 to 1:1,000:10,000:10,000. The molar ratio of photosensitizer:annihilator compound can be, for example 1:10 to 1:1,000, or 1:10 to 1:500, or 1:10 to 1:250, or 1:10 to 1:200, or 1:10 to 1:100, or 1:10 to 1:50, or 1:10 to 1:20. The molar ratio of photosensitizer:photoinitiator can be, for example, 1:1 to 1:10,000, or 1:10 to 1:1,000, or 1:10 to 1:500, or 1:10 to 1:100, or 1:10 to 1:50. The molar ratio of photosensitizer:oxygen scavenger can be, for example, 1:10 to 1:10,000, or 1:10 to 1:1,000, or 1:10 to 1:500, or 1:10 to 1:100, or 1:10 to 1:50. In a specific aspect, the photosensitizer, the annihilator compound, the photoinitiator, and the oxygen scavenger can be present in a molar ratio of photosensitizer:annihilator compound:photoinitiator:oxygen scavenger of 1:10:100:100 to 1:50:500:500, for example 1:10:200:200.

In addition to the photosensitizer, the annihilator compound, the photoinitiator, and, optionally, the oxygen scavenger, the photocurable composition further includes a monomer composition. The monomer composition comprises one or more monomers capable of reacting with the reactive species generated from activation of the photoinitiator to provide a polymer. Accordingly, suitable monomer species will depend on the identity of the photoinitiator and the polymerization mechanism enabled by the photoinitiator. The monomer composition can therefore include a free radically polymerizable monomer (e.g., when a radical-generating initiator is used), a cationically polymerizable monomer (e.g., when a photoacid generator is used as the initiator), an anionically polymerizable monomer (e.g., when a photobase generator is used as the initiator), or a combination thereof (e.g., when a combination of photoinitiators are used which are capable of promoting different polymerization mechanisms, for example radical and cationic).

In an aspect, the monomer composition comprises a free radically polymerizable monomer having ethylenic unsaturation. Exemplary free radically polymerizable groups can include, but are not limited to, acrylates, methacrylates, acrylamides, methacrylamides, alkenyl aromatics (e.g., styrene and derivatives thereof), vinyl groups (e.g., vinyl acetate), or a combination thereof.

In some aspects, the monomer composition can comprise a monomer comprising an epoxy functional group, an isocyanate functional group, an isothiocyanate group, a carbonate group, an ester group, a vinyl sulfone group, a hydroxyl group, a thiol group, an alkynyl group, or a combination thereof.

In an aspect, particularly when the photoinitiator comprises a photoacid generator, the monomer composition can comprise a cationically polymerizable group such as a cyclic ether (e.g., an epoxy group, an oxetane group, or the like), a vinyl ether, an oxetane, a spiro-orthocarbonate, a spiro-orthoester, or a combination thereof. In a specific aspect, the cationically polymerizable group can comprise a cycloalkyl ether cationically polymerizable group, preferably an epoxy.

In an aspect, particularly when the photoinitiator comprises a photobase generator, the monomer composition can comprise a first monomer including at least two hydroxyl groups, at least two thiol groups, or a combination thereof. Non-limiting examples of the first monomer comprising at least two thiol groups can include trimethylolpropane tris(3-mercaptopropionate); trimethylolpropane tris(2-mercaptoacetate); pentaerythritol tetrakis(2-mercaptoacetate); pentaerythritol tetrakis(3-mercaptopropionate); ethoxylated trimethylolpropane tri (3-mercaptopropionate), 2,2′-(ethylenedioxy)diethanethiol; 3,6-dioxa-1,8-octane-dithiol; 1,3-propanedithiol; 1,2-ethanedithiol; 1,4-butanedithiol; 1,5-pentanedithiol; 1,6-hexanedithiol; 1,9-nonanedithiol; xylene dithiol; thiobis(benzenethiol); 1,4-butanediol bis(thioglycolate); 1,4-bis(3-mercaptobutylyloxy)butane; tris[2-(3-mercaptopropionyloxy)ethyl] isocyanurate; 3,4-ethylenedioxythiophene; 1,10-decanedithiol; tricyclo[5.2.1.02,6]decanedithiol; benzene-1,2-dithiol; trithiocyanuric acid; 1-butanethiol; 1-hexanethiol; 1-heptanethiol; 1-octanethiol; 1-nonanethiol; 1-decanethiol; and 1-octadecanethiol. The monomer composition can further comprise a second monomer including at least two (meth)acrylate groups, at least two (meth)acrylamide groups, at least two vinyl sulfone groups, at least two isothiocyanate groups, at least two isocyanate groups, at least two epoxide groups, at least two carbonate groups, at least two ester groups, at least two alkynyl groups, or a combination thereof. Diisocyanates are specifically mentioned. Non-limiting examples of suitable aliphatic isocyanates include ethylene diisocyanate, trimethylene diisocyanate, 1,6-hexamethylene diisocyanate (HDI), tetramethylene diisocyanate, octamethylene diisocyanate, nonamethylene diisocyanate, decamethylene diisocyanate, 1,6,11-undecanetriisocyanate, 1,3,6-hexamethylene triisocyanate, bis(isocyanatoethyl)-carbonate, bis(isocyanatoethyl)ether. Other non-limiting examples of suitable aliphatic isocyanates include branched isocyanates such as trimethylhexane diisocyanate, trimethylhexamethylene diisocyanate (TMDI), 2,2′-dimethylpentane diisocyanate, 2,2,4-trimethylhexane diisocyanate, 2,4,4-trimethylhexamethylene diisocyanate, 1,8-diisocyanato-4-(isocyanatomethyl)octane, 2,5,7-trimethyl-1,8-diisocyanato-5-(isocyanatomethyl) octane, 2-isocyanatopropyl 2,6-diisocyanatohexanoate, lysinediisocyanate methyl ester and lysinetriisocyanate methyl ester. Non-limiting examples of suitable cycloaliphatic isocyanates include dinuclear compounds bridged by an isopropylidene group or an alkylene group of 1 to 3 carbon atoms. Non-limiting examples of suitable cycloaliphatic isocyanates include 1,1′-methylene-bis-(4-isocyanatocyclohexane), 4,4′-methylene-bis-(cyclohexyl isocyanate) or 4,4′-dicyclohexylmethane diisocyanate, 4,4′-isopropylidene-bis-(cyclohexyl isocyanate), 1,4-cyclohexyl diisocyanate (CHDI), 3-isocyanato methyl-3,5,5-trimethylcyclohexyl isocyanate (a branched isocyanate also known as isophorone diisocyanate or IPDI). In an aspect, the second monomer can comprise hexamethylene diisocyanate; isophorone diisocyanate; diisocyanatobutane; diisocyanatooctane; 1,3,5-tris(6-isocyanatohexyl)-1,3,5-triazinane-2,4,6-trione; phenylene diisocyanate; xylylene diisocyanate; tolyene diisocyanate; cyclohexylene diisocyanate; toluene diisocyanate; methylenebis(phenyl isocyanate); propyl isocyanate; 1-pentyl isocyanate; hexyl isocyanate; octyl isocyanate; nonyl isocyanate; sec-butyl isocyanate; 2-ethylhexyl isocyanate; cyclopentyl isocyanate; and 1-isocyanato-3-methylbutane. Use of poly(ethylene glycol) or poly(propylene glycol) diisocyanate terminated polymers are also mentioned (e.g., tolylene 2,4-diisocyanate terminated-poly(propylene glycol) having a number average molecular weight of 1,000 to 5,000 grams per mole). The first and second monomers can be selected to provide a (polyester-sulfide) (e.g., comprising —O(C═O)-L-S— linkages, wherein L is a linking group, for example a C₁₋₆ alkylene linking group), a poly(amide-sulfide), a poly(sulfone-sulfide), a poly(urethane) (e.g., comprising a —NH(C═O)O— linkage), a poly(thiourethane) (e.g., comprising a —NH(C═O)S— linkage), a poly(dithiourethane) (e.g., comprising a —NH(C═S)S— linkage), a poly(carbonate-sulfide) (e.g., comprising a —O(C═O)O-L-S— linkage, wherein L is a linking group, for example a C₁₋₆ alkylene linking group), or a poly(ether-sulfide).

The monomer composition can optionally comprise a crosslinker. As used herein the term “crosslinker” refers to a compound having three or more polymerizable groups and is thus capable of generating a chemically crosslinked polymer matrix when present. Exemplary crosslinkers can include, but are not limited to, vinylic crosslinkers, isocyanate crosslinkers, epoxide crosslinkers, thiol crosslinkers, alkynyl crosslinkers, acrylic acid esters of polyols, methacrylic acid esters of polyols and allyl ethers of polyols each of which has hydroxyl groups substituted with at least two substituents. Examples of the above polyols include ethylene glycol, propylene glycol, polyoxyethylene glycol, polyoxypropylene glycol, glycerin, polyglycerin, trimethylolpropane, pentaerythritol, sucrose, sorbitol and the like. Additional examples of crosslinkers can include divinylbenzene, N,N′-methylenebis(acrylamide), N,N′-ethylenebis(acrylamide), N,N′-propylenebis(acrylamide), N,N′-butamethylenebis(acrylamide), N,N′-diallylacrylamide, N,N′-hexamethylenebisacrylamide, triallylisocyanurate, 1,4-diacryloylpiperazine-1,1,1-trimethylolpropane diallyl ether, triethylene glycol divinyl ether, diallyl maleate, bis(acryloylamido)methane, ethyleneglycoldimethacrylate, diethyleneglycoldimethacrylate, 3-(acryloyloxy)-2-hydroxypropyl methacrylate, 1,6-hexanediol diacrylate, tripropylene glycol diacrylate, diallyl phthalate, triallyl phosphate, allyl methacrylate, tetraallyloxyethane, triallyl cyanurate, divinyl adipate, vinyl crotonate, 1,5-hexadiene, allyl glycidyl ether, and pentaerythritol tetraallyl ether.

The monomer composition is liquid at room temperature (e.g., at 25° C.) and is capable of dissolving the other components of the photocurable composition. In an aspect, the photocurable composition can optionally further comprise a suitable solvent. When present, the solvent is selected to sufficiently dissolve or disperse the components of the photocurable composition. Suitable solvents can be selected based on the selected components and guided by the present disclosure. Exemplary solvents can include but are not limited to tetrahydrofuran, dimethylformamide, N-methylformamide, formamide, acetonitrile, dimethylacetamide, dimethylacetamide, propylene carbonate, ethylene carbonate, N-methylpyrrolidone, dimethylsulfoxide, and combinations thereof. In an aspect, the photocurable composition does not include a solvent.

In an aspect, the curable composition can optionally further comprise an additive, provided that the presence of the additive does not significantly adversely affect one or more desired properties of the curable composition, the light-based method of curing, or the final cured composition. When present, additive(s) can be mixed with the photocurable composition at any suitable time during the mixing of the components for forming the composition. In an aspect, the photocurable composition can include a filler (e.g., glass, carbon, mineral, or metal) or reinforcing agent. Additives can be used in amounts generally known to be effective.

The photocurable composition of the present disclosure can optionally exclude other components not specifically provided for herein. For example, the photocurable composition can exclude a solvent. The photocurable composition can exclude a compound having a triplet energy state lower in energy than both the photosensitizer and the annihilator compound (also referred to in the art as an “acceptor”). In an aspect, the photocurable composition can exclude a surfactant or other micelle-forming agent. In some aspects, the photocurable composition does not include a carrier material or encapsulant (e.g., nanocapsules) to encapsulate or otherwise contain any components of the composition.

In an aspect, the photocurable composition can comprise the photosensitizer; the annihilator compound; the photoinitiator; the monomer composition; and, optionally, an oxygen scavenger. In a specific aspect, the photocurable composition comprises 0.01 to 1, preferably 0.4 to 0.8 millimoles per liter of the photocurable composition of the photosensitizer; 1 to 10, preferably 4 to 8 millimoles per liter of the photocurable composition of the annihilator compound; and 20 to 40, preferably 25 to 35 millimoles per liter of the photocurable composition of the photoinitiator. The photosensitizer can comprise a platinum-containing porphyrin, preferably platinum octaethylporphyrin. The annihilator compound can comprise a substituted or unsubstituted diphenyl anthracene. The photoinitiator can comprise a bisacylphosphine oxide, preferably phenylbis(2,4,6-trimethylbenzoyl)phosphine oxide. In another specific aspect, the photocurable composition can comprise 0.0001 to 1, preferably 0.04 to 0.06 millimoles per liter of the photocurable composition of the photosensitizer; 0.01 to 10, preferably 0.4 to 0.8 millimoles per liter of the photocurable composition of the annihilator compound; 0.1 to 500, preferably 5 to 15 millimoles per liter of the photocurable composition of the photoinitiator; and 1 to 100, preferably 5 to 15 millimoles per liter of the photocurable composition of an oxygen scavenger. The photosensitizer can comprise a palladium-containing porphyrin, preferably a palladium tetraphenylporphyrin. The annihilator compound can comprise a substituted or unsubstituted diethynyl anthracene. The photoinitiator can comprise a dialkyl germanium, preferably bis(4-methoxybenzoyl)diethylgermanium. The oxygen scavenger can comprise triphenylphosphine.

The photocurable composition of the present disclosure can be used to provide a corresponding cured composition, for example by photoinitiating a chemical reaction of the monomer composition in the presence of a suitable wavelength of light. The wavelength of light used to irradiate the photocurable composition can be selected based on the chemical structure of the photosensitizer and the photoinitiator, guided by the present disclosure. The cured composition can be a three-dimensional structure formed using the methods described herein.

Accordingly, another aspect of the present disclosure is a method for photopolymerizing the photocurable composition described here. In an aspect, the method can provide a photocured polymer composition. The method comprises irradiating the photocurable composition with a first wavelength of light to provide the cured composition. As described above, the first wavelength of light is absorbed by the photosensitizer to provide the photosensitizer in a first triplet state. The annihilator compound accepts triplet energy transfer from the first triplet state of the photosensitizer and emits a second wavelength of light. The second wavelength of light is less than the first wavelength of light (i.e., the second wavelength of light is blue-shifted relative to the first wavelength of light). The second wavelength of light is absorbed by the photoinitiator to generate a reactive species capable of initiating polymerization of the monomer composition. The identity of the reactive species and thus the mechanism of polymerization will depend on the type of photoinitiator selected.

In an aspect the first wavelength of light is in the range of 400 to 1000 nanometers, for example 400 to 800 nanometers, or 450 to 750 nanometers. Advantageously, the first wavelength of light can be at a relatively low intensity, for example less than 10 mW/cm². In an aspect, the light intensity can be 0.1 to less than 10 mW/cm², or 0.5 to less than 10 mW/cm², or 1 to less than 10 mW/cm², or 2 to 8 mW/cm², or 3 to 7 mW/cm², or 4 to 6 mW/cm², or 1 to 8 mW/cm², or 1 to 7 mW/cm², or 1 to 6 mW/cm², or 1 to 5 mW/cm², or 0.5 to 8 mW/cm², or 0.5 to 7 mW/cm², or 0.5 to 6 mW/cm², or 0.5 to 5 mW/cm², or 0.1 to 8 mW/cm², or 0.1 to 7 mW/cm², or 0.1 to 6 mW/cm², or 0.1 to 5 mW/cm². Combinations of any of the above are also possible in certain aspects. In an aspect, the light source can be a light emitting diode.

In another advantageous feature, the present inventors have found that the present method can be conducted in the presence of ambient oxygen. The temperature of the reaction is not particularly limited as long as the reaction proceeds. For example, the method can be conducted at a temperature of 0 to 100° C., for example 10 to 60° C., or 20 to 40° C. The gelation time of the photocurable composition can be 60 seconds or less, or 1 to 30 seconds, or 1 to 15 seconds. Such timescales (e.g., 15 seconds or less) can be particularly useful for applications of the disclosed method to lithography or 3D printing (additive manufacturing). Thus in some aspects, the method can be a three dimensional printing method, preferably a light-based additive manufacturing method, more preferably digital light processing, stereolithography, or computed axial lithography.

In an aspect, the method can be a light-based additive manufacturing method (e.g., a digital light processing method) wherein the method comprises irradiating a first portion of the curable composition with the first wavelength of light to induce polymerization of the monomer composition to form a first layer on a substrate. The light can be provided by a light source comprising a light emitting diode. The light source can be an incoherent light source. The method further comprises forming at least one additional layer on the first layer by irradiating a second portion of the curable composition to induce polymerization to form the additional layer. The method steps of irradiating and forming the layers can be repeated until a desired number of layers are formed to provide the three-dimensional structure. In an aspect, each layer can comprise a crosslinked polymer matrix derived from the first and second monomers. In an aspect, adjacent layers may be chemically bonded at an interface between the layers. In an aspect, the method can have a print rate of 60 second/layer or less, or 30 seconds/layer or less, 15 seconds/layer or less, or 10 seconds/layer or less. In an aspect, the method can have a print rate of 1 millisecond/layer or more, for example 50 milliseconds/layer or more, 1 second/layer or more, 5 seconds/layer or more, 10 seconds/layer or more, 15 seconds/layer or more, 20 seconds/layer or more, or 25 seconds/layer or more. The print rate can range from any of the minimum values described above to any of the maximum values described above. For example, the method can have a print rate of from 1 millisecond/layer to 30 seconds/layer, or from 1 millisecond/layer to 25 seconds/layer, from 1 millisecond/layer to 20 seconds/layer, from 1 millisecond/layer to 15 seconds/layer, from 1 millisecond/layer to 10 seconds/layer, or from 1 millisecond/layer to 5 seconds/layer.

In an aspect, the 3D printing can be accomplished with the present photocurable composition in a digital light processing (DLP) method. In a 3D printer for a DLP method, the photocurable composition in liquid form can be provided in a vat or spread on a sheet. A predetermined area of the photocurable composition can be exposed to the selected wavelength of light (e.g., UV or visible light having a wavelength selected to activate the photoradical generator or the photoacid generator). The irradiation with light can be controlled by a digital micro-mirror device or a rotating mirror. In DLP, additional layers are repeatedly or continuously laid and each layer is cured until the desired 3D article is provided.

This disclosure is further illustrated by the following examples, which are non-limiting.

### EXAMPLES

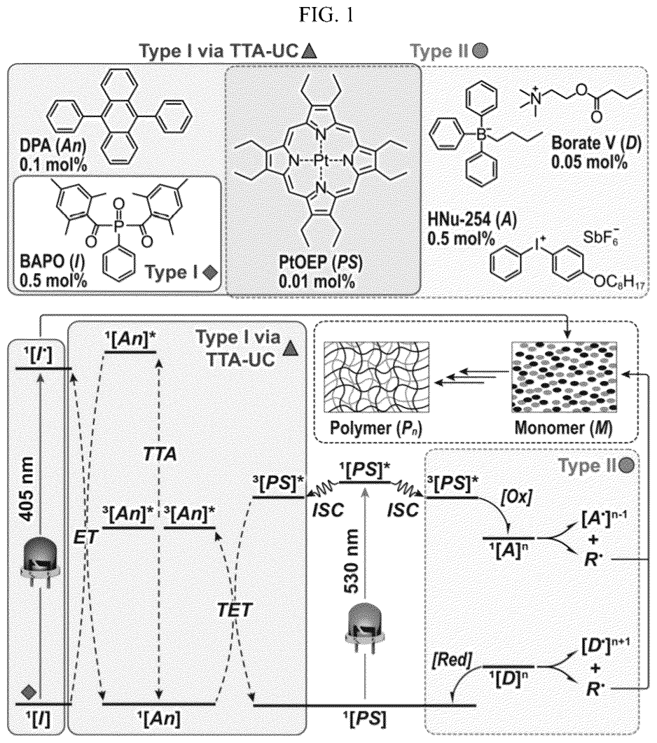

The photopolymerization system used in the present examples couples two distinct processes, TTA-UC and Type I photoinitiation (i.e., unimolecular bond homolysis postexcitation) (FIG. 1). The TTA-UC cascade begins with absorption of a low energy (~525 nm, green light) photon by the photosensitizer (PS), platinum octaethylporphyrin (PtOEP). The resultant spin-singlet excited state (¹[PS]*) of PtOEP then undergoes rapid intersystem crossing (ISC) to a long-lived spin-triplet excited state (³[PS]*). Next, this photoexcitation is transferred to 9,10-diphenylanthracene (DPA), a common annihilator (An) whose lower triplet energy relative to PtOEP (E_{T,PtOEP}=1.91 eV vs E_{T,DPA}=1.77 eV) enables triplet energy transfer (TET) between these compounds. Triplet-triplet annihilation (TTA) can then proceed when two annihilators in their triplet excited state, ³[An]*, collide, yielding one ground-state annihilator, ¹[An], and one annihilator in its singlet excited state, ¹[An]*. The excited spin-singlet annihilator can then emit a high-energy photon (~420-440 nm, violet-blue light) that can be absorbed by phenylbis(2,4,6-trimethylbenzoyl)-phosphine oxide (BAPO), an efficient Type I photoinitiator that does not absorb the low-energy green photons emitted by the LED being used to excite PtOEP. In addition to emission reabsorption, BAPO can be activated via energy transfer from ¹[An]*. In either case, the excited initiator (¹[I]*) will cleave in a homolytic fashion to yield two radicals capable of initiating polymerization.

As a benchmark, this process was directly compared with an analogous Type II photopolymerization system driven by green light (FIG. 1, left). In this photosystem, PtOEP serves as a photoredox catalyst (labeled for simplicity as PS), while diphenyliodonium and n-butyl triphenylborate salts serve, respectively, as electron acceptor (A) and donor (D) components, completing an efficient redox cycle where radicals are generated on both ends. In addition, polymerizations driven via direct photoexcitation (~405 nm, UV/violet light) of the Type I photoinitiator, BAPO, served as controls.

Several acrylate monomers were initially screened with the TTA-UC system, namely, isobornyl acrylate, dimethyl acrylamide, carbitol acrylate, and 2-phenoxyethyl acrylate (PhOEA). Of these four monomers, 2-phenoxyethyl acrylate provided the best combination of solubility and polymerization rate and was therefore used for all further photophysical and polymerization studies. Notably, although uncommon in photocurable resins, 2-phenoxyethyl acrylate is an inexpensive monomer derived from the commodity chemical phenoxyethanol, making it of viable utility in commercial additive manufacturing.

As a first step toward TTA-UC-based photopolymerization, the upconversion quantum efficiency (Φ_{UC}) and intensity threshold (Iₜₕ) of the PtOEP/DPA TTA-UC system was characterized via photoluminescence spectroscopy under an inert nitrogen atmosphere. To preclude DPA fluorescence quenching, measurements were performed in the absence of BAPO (i.e., using only PtOEP and DPA). To match the polymerization conditions described later, PtOEP and DPA were dissolved in 2-phenoxyethyl acrylate at concentrations of 0.6 and 6 mM, respectively. Exposure of this mixture to 50 mW/cm² 532 nm green laser light resulted in no observable DPA fluorescence (FIG. 2), despite prior reports of TTA-UC occurring for PtOEP/DPA mixtures at <50 mW/cm², albeit in more traditional solvents (e.g., toluene). Increasing the excitation intensity (Iₑₓ) to 1000 mW/cm² resulted in DPA fluorescence monitored at 436 nm that grew in intensity during the first ~30 s of exposure. After ~60 s, the DPA fluorescence decreased, concomitant with the appearance of a red emission band centered at ~645 nm that was attributed to PtOEP phosphorescence. Upon concluding the experiment, the formation of solid inside the cuvette at the position of irradiation was observed, indicating that the PtOEP/DPA TTA-UC system can initiate photopolymerization in the absence of BAPO, although it requires high Iₑₓ and exposure times. In the case of DPA, the energy of ¹[An]* is too low to initiate acrylate polymerization, which was confirmed experimentally through direct excitation of DPA in monomer. As such, an alternate initiation pathway within the TTA-UC photosystem must exist, which, could occur via electron transfer to monomer from a high-energy coupled triplet pair state that forms upon TTA prior to ¹[An]*.

The time evolution of emission from the TTA-UC system (FIG. 2) was attributed to photoinduced electron transfer from DPA to acrylate, which was recently shown to be a viable initiation mechanism for photopolymerization. It was hypothesized that upon light exposure, upconverted fluorescence quenching by 2-phenoxyethyl acrylate occurs, leading to the weak TTA-UC observed. Over time, the local concentration of monomer, acting as a DPA quencher, decreases due to polymerization, leading to a slow gain in DPA fluorescence with continued light exposure. Eventually, however, polymerization increases the viscosity of the solution to a point that diffusion-based TET from PtOEP to DPA and TTA between triplet excited DPA (³[An]*) molecules is severely hindered, leading to a decrease in DPA fluorescence and increase in PtOEP phosphorescence. Notably, the changes in photoluminescence from blue to red emission are visible to the naked eye, providing visual cues that uniquely enable qualitative tracking of this process.

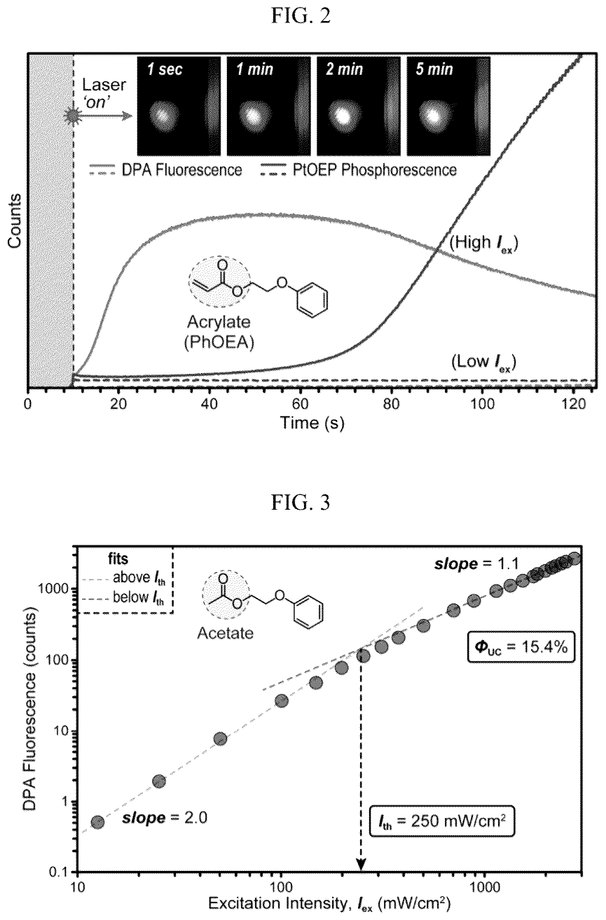

Although the time-dependent emission behavior observed in 2-phenoxyethyl acrylate was unique, DPA quenching by the monomer precluded quantitative determination of Φ_{UC} and Iₜₕ for the PtOEP/DPA TTA-UC system. To bypass this issue, 2-phenoxyethyl acrylate was replaced with an analogous nonpolymerizable solvent, 2-phenoxyethyl acetate. Using the same concentrations of PtOEP (0.6 mM) and DPA (6 mM) as for photopolymerization (described below), the DPA fluorescence intensity at 436 nm was tracked as a function of 532 nm Iₑₓ (FIG. 3). Plotting the results on a log-log scale revealed a change in slope from ~2 to 1 at Iₑₓ≈250 mW/cm₂, which identifies Iₜₕ. Below Iₜₕ, spontaneous decay of ³[An]* is rate limiting, whereas above Iₜₕ TTA becomes the dominant and thus rate-limiting pathway. This behavior for TTA-UC systems can be described using Equation (1):

$${I}_{th} = \frac{2 {( {k}_{An}^{T} )}^{2}}{α {ϕ}_{TET} {γ}_{TTA}} \qquad ( 1 )$$

where k_{An}^{T} is the ³[An]* decay rate constant, α is the PS absorption coefficient, φ_{TET} is the TET efficiency from ³[PS]* to ¹[An], and γ_{TTA} is the TTA second-order rate constant.

To estimate Iₜₕ in acrylate relative to the acetate (proxy) solvent, each component of Equation 1 was systematically characterized apart from γ_{TTA}, which was qualitatively compared between the two solvents based on the ³[An]* decay rates. Under equimolar conditions that provide high optical densities, a is similar in both acrylate and acetate. To characterize φ_{TET} in each solvent, time-resolved photoluminescence spectroscopy under an inert nitrogen atmosphere was used to measure changes in the PtOEP phosphorescence lifetime due to quenching by DPA. In the absence of DPA, the lifetime of PtOEP was found to be ~79 and ~52 μs in acrylate and acetate solvents, respectively. The addition of 6 mM DPA to each solution decreases these values to ~1.9 μs in both solvents, indicating that φ_{TET} is >96%. The k_{An}^{T} values were extracted using transient absorption spectroscopy by monitoring the decay of an induced absorption signal from ³[An]* at 475 nm, which yielded lifetimes of 280 μs (k_{An}^{T}≈3570 s⁻¹) and 122 μs (k_{An}^{T}≈8190 s⁻¹) in acrylate and acetate, respectively. These lifetimes are considerably shorter than those obtained in common solvents with lower photosystem concentrations (e.g., ~8 ms in toluene). The shorter lifetimes observed in the present system are hypothesized to arise from DPA to PtOEP back energy transfer that is promoted by the high PS concentration employed. This concentration was selected to match that used in the optimized resin (described below), which represents an application-oriented approach to designing TTA-UC systems. Furthermore, fitting the decay traces revealed that γ_{TTA} was larger in acrylate relative to acetate, indicating that a higher fraction of ³[An]* undergoes TTA in acrylate. Given the squared dependence of Iₜₕ on k_{An}^{T} (Eq. 1), it was estimated that Iₜₕ is <47 mW/cm² in acrylate, which is >5× lower than acetate. Thus, the TTA-UC system was anticipated to operate effectively under excitation intensities relevant to DLP 3D printing. Further supporting this expectation was the high maximum Φ_{UC}, which was measured as 15.4% in acetate, albeit at high Iₑₓ values (3000 mW/cm²). Notably, this Φ_{UC} value is out of a maximum of 50% (theoretical TTA-UC limit) and is conservative given a lack of correction for inner filter effects. Despite the stark disparity in Iₜₕ when using acetate versus acrylate as the solvent, it was hypothesized that the maximum Φ_{UC} is comparable in these two solvents given the governing factors provided in Equation 2:

$${Φ}_{UC} = \frac{1}{2} {ϕ}_{ISC} {ϕ}_{TET} {ϕ}_{TTA} f {ϕ}_{fl} \qquad ( 2 )$$

where φ_{ISC} is the ISC efficiency of the PS (PtOEP), φ_{TTA} is the TTA quantum yield, f is the spin-statistical factor (i.e., the probability of forming an excited singlet state upon TTA), and φ_{fl} is the An (DPA) fluorescence quantum yield. Given a common PS (PtOEP) that leverages spin-orbit coupling from the heavy Pt atom to drive ISC, φ_{ISC} was assumed to be similar in acrylate and acetate. As discussed previously, φ_{TET} is near unity in both systems due to the high An (DPA) concentration employed. Additionally, φ_{TTA} approaches unity at excitation intensities Iₜₕ irrespective of solvent. Finally, the effect of acrylate versus acetate solvent on φ_{fl} was probed by characterizing the fluorescence lifetime (τ_{fl}) of DPA after 375 nm excitation. A τ_{fl} value of 6.8 ns was found in both solvents, which is nearly identical to τ_{fl} in toluene (6.9 ns), where φ_{fl} is near unity. This suggests that φ_{fl} should be similar and close to unity in both acetate and acrylate. Together, these results highlight that the present TTA-UC system operates efficiently with an uncorrected φ_{UC} of 15.4% in acetate (compared to ~18-26% in other solvents), which, based on spectroscopic results, is estimated to be of a comparable value in acrylate.

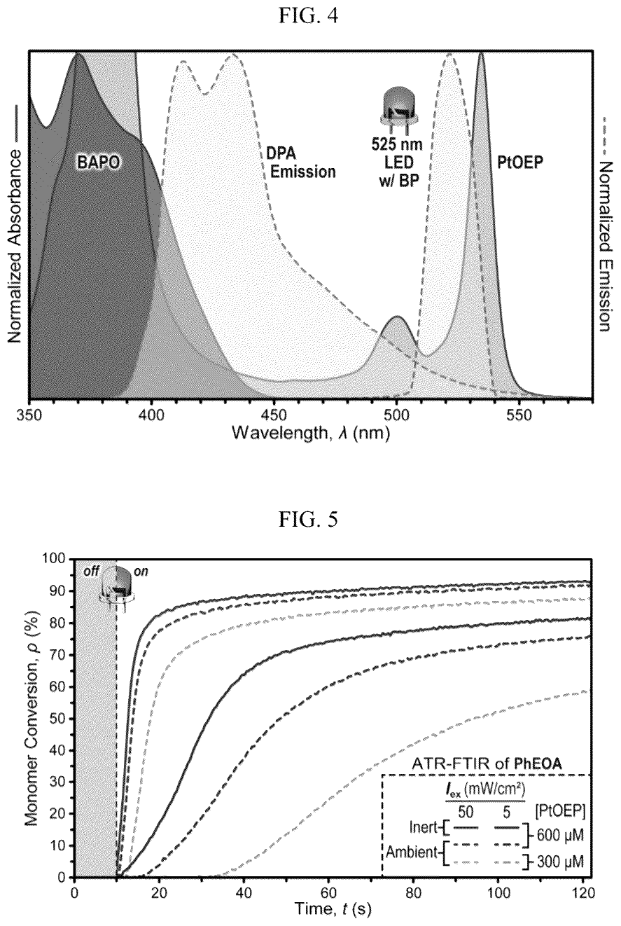

Having characterized the upconversion system, it was next employed to drive a classic Type I photopolymerization, using BAPO as the initiator (I), as its absorption spectrum shows good overlap with the emission spectrum of DPA (FIG. 4). A standard green LED (λₘₐₓ=525 nm) was selected as the excitation light source, as its emission profile overlapped well with the absorption profile of PtOEP used in both the TTA-UC and Type II photosystems without being absorbed by BAPO. Additionally, the LED was equipped with a 525×25 nm bandpass (BP) filter to ensure selective absorption by PtOEP. However, it is worth noting that spectral overlap may not always be a direct predictor of photochemical reactivity, and thus, systematic controls (described below) were completed to confirm that the proposed TTA-UC to Type I initiation mechanism was indeed occurring.

Initial resin formulation optimization focused on maximizing the rate of polymerization (rₚ) by adjusting photosystem component concentrations. Real-time Fourier transform infrared spectroscopy (RT-FTIR) performed in an attenuated total reflectance (ATR) configuration was used to quantify rₚ by measuring the conversion of monomer to polymer (ρ) via loss of the monomer C═C stretching band at ~808 cm⁻¹. Optimization via RT-FTIR kinetics led to a resin including 0.01 mol % (~600 μM) PtOEP, 0.1 mol % DPA, and 0.5 mol % BAPO, a PS:An:I ratio of 1:10:50. The PS and An concentrations in the present system were similar to those used for upconversion in soft materials (~500 μM and ~13.4 mM, respectively), yet they are notably higher than what is traditionally employed for TTA-UC (~5 μM and 1 mM, respectively). It is believed that higher concentrations are needed in the present resins to overcome oxygen inhibition, operate in a viscous medium, and induce rapid curing upon exposure to low intensity light, as required for 3D printing. Additionally, the I concentration corresponds to 1 wt % in the resin formulation, which is within the standard range of Type I photoinitiators used in photocurable resins (~0.5-5 wt %). This I concentration falling at the lower end of the commercial use range has the added potential benefit of improving resin stability to accidental ambient light exposure.

Photopolymerizations with the optimized formulation were conducted using Iₑₓ values of 5 and 50 mW/cm² under both ambient and inert (argon) atmospheric conditions. In the absence of oxygen, excellent temporal control was observed, where polymerization began right after turning the LED “on” (FIG. 5). The rₚ, measured as the initial slope of monomer C═C conversion, was 109±6.4 and 901±41 mM/s for Iₑₓ values of 5 and 50 mW/cm², respectively (FIG. 5), under inert conditions. As a control, resins without An (i.e., only PS and I present) did not polymerize upon exposure to the 525 nm LED (50 mW/cm²). In contrast, under the same excitation conditions (525 nm LED, 50 mW/cm²), control resins without I (i.e., only PS and An present) showed a very slow polymerization (rₚ=5.3±0.5 mM/s), consistent with the aforementioned solid formation observed during Φ_{UC} characterization. Also of note, a redshifted Type I acylgermane initiator (Ivocerin) was examined to increase the absorption overlap with upconverted DPA fluorescence. However, only modest improvements in rₚ (≤15% increase) were measured relative to analogous resins with BAPO. Returning to the TTA-UC photosystem containing BAPO, the maximum C═C conversion (ρₘₐₓ) was 82±2% and 93±1% for Iₑₓ=5 and 50 mW/cm², respectively (FIG. 5). The incomplete C═C conversion was attributed to the increase in viscosity upon polymerization, which hinders diffusion-limited processes. Notably, the 11% larger ρₘₐₓ observed when using the higher Iₑₓ may be rationalized by the larger rₚ and concomitant heat released from the exothermic reaction propagation, which can facilitate diffusion and thereby higher conversion.

Irradiating the same mixtures under ambient conditions resulted in rₚ=85±7 mM/s and ρₘₐₓ=75±1% for Iₑₓ=5 mW/cm², while increasing Iₑₓ to 50 mW/cm² boosted these values to rₚ=834±34 mM/s and ρₘₐₓ=92±1% (FIG. 5). Notably, the rₚ at 50 mW/cm² under ambient conditions was only 7% smaller than under inert conditions. This apparent low sensitivity to oxygen is attributed to triplet quenching rates that outcompete the rate of oxygen diffusion facilitated by the high PS concentration (~600 μM), despite the relatively low viscosity (η) of the photopolymerizable resin (ηₘₒₙₒₘₑᵣ≈11 mPa·s), which was expected to enhance oxygen quenching. Moreover, DPA has been shown to act as a singlet oxygen scavenger. The low oxygen sensitivity is unprecedented for TTA-UC and provides a key avenue toward commercial additive manufacturing that is predominantly accomplished under ambient conditions. The effect of oxygen, however, is more apparent at Iₑₓ=5 mW/cm², where an inhibition time (tᵢₙₕ) (i.e., period of no conversion after light “on”) of ~4 s emerges (FIG. 5). The tᵢₙₕ likely corresponds with the time it takes to fully consume oxygen in the irradiation zone. This effect was further pronounced upon diluting the photosystem to ½ of the original formulation (i.e., 300 μM PtOEP, FIG. 5) and 1/10 (i.e., 60 μM PtOEP). At ½ the original concentration under ambient conditions, rₚ was 56±3 mM/s, ρₘₐₓ was 59±2%, and tᵢₙₕ was 21±1 s for Iₑₓ=5 mW/cm². Increasing Iₑₓ to 50 mW/cm² heightened these values to rₚ=504±25 mM/s, ρₘₐₓ=87±1%, and tᵢₙₕ=2.0±0.2 s under ambient conditions.

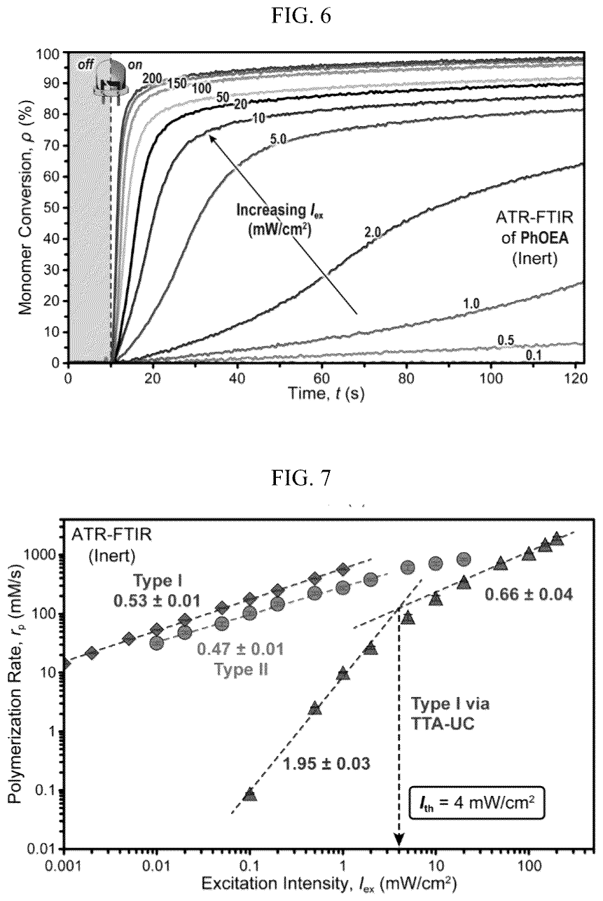

Given the large apparent influence of Iₑₓ on the photopolymerization kinetics, its impact on the behavior of the optimized TTA-UC resin was characterized (FIG. 6). Samples were measured under an inert atmosphere to allow intrinsic TTA-UC characteristics, such as Iₜₕ and rₚ, to be quantified in the absence of oxygen inhibition. Iₑₓ was varied by more than 3 orders of magnitude, from 0.1 to 200 mW/cm². This resulted in rₚ values ranging over 4 orders of magnitude, from 0.11±0.01 to 2200±150 mM/s. Plotting rₚ versus Iₑₓ on a double logarithmic scale revealed two linear regimes with distinct slopes that converge at Iₑₓ≈4 mW/cm² (FIG. 7). In the low Iₑₓ region (<4 mW/cm²), the slope is superlinear (1.95±0.03), which lies between the expected slope of 1 and 3 for a two-photon-initiated polymerization. A slope of 1 would occur in an ideal two-photon process, while factors such as the presence of radical scavengers (e.g., oxygen) or radical occlusion (i.e., unimolecular termination) can increase the slope up to 3. In the present system, trace oxygen is hypothesized to result in the measured slope >1 at low excitation intensities due to the inherent oxygen sensitivity of TTA-UC. In the high Iₑₓ region (>4 mW/cm²), the slope becomes sublinear (0.66±0.04), which is close to the expected slope of 0.5 for one-photon-initiated polymerizations that operate under conventional bimolecular termination events (i.e., rₚ∝Iₑₓ ½). The observable trends of Iₑₓ on polymerization kinetics are analogous to that observed for upconverted photoluminescence via the TTA mechanism. Moreover, the two fitted slopes intersect at ~4 mW/cm² (≈Iₜₕ), which is within the predicted range for Iₜₕ based on Equation 1 but notably lower than the upper limit (<47 mW/cm²). Taken together, these results suggest that monitoring rₚ as a function of Iₑₓ provides an effective method to experimentally determine Iₜₕ for photopolymerizations driven by a two-photon process.

To confirm that the superlinear behavior was unique to TTA-UC-based Type I photopolymerizations, rₚ values for the PtOEP/DPA/BAPO system were compared with those obtained by direct excitation of the benchmark Type I and Type II photosystems detailed in FIG. 1 (FIG. 7). For the Type I photopolymerization, BAPO was employed as the photoinitiator at a concentration equimolar to that used in the optimized TTA-UC formulation (30 mM) and was photoexcited using a 405 nm UV/violet LED whose output was tuned to provide/ex values from 0.001 to 1 mW/cm². Likewise, Type II photopolymerizations were performed using a concentration of PtOEP equimolar to that employed in the optimized TTA-UC formulation (600 μM) along with 50 and 5 equiv (30 and 3 mM, respectively) of diphenyliodonium and n-butyl triphenylborate salts as the electron acceptor and donor, respectively. The same 525 nm LED with a 525×25 nm bandpass filter used for the TTA-UC resin was again employed for the Type II photosystem, with Iₑₓ values ranging from 0.01 to 20 mW/cm² to provide comparable rₚ values.

Examining the performance of the Type I photosystem as a function of Iₑₓ revealed rₚ values from 17.3±1.1 to 679±2.0 mM/s and a sublinear relationship (slope=0.53±0.01) over the full range of rₚ values when plotting on a double logarithmic scale (FIG. 7). Similarly, the Type II system yields rₚ values that display a sublinear dependence on Iₑₓ (slope=0.47±0.01), which becomes even more pronounced (slope <0.3) at higher excitation intensities due to undesirable side reactions (FIG. 7). Although direct activation of both the Type I and Type II resins provided high rₚ's at low Iₑₓ's, the sublinear relationship between the two is expected to limit spatial resolution by facilitating overcure from scattered light and light transmitted beyond the depth of a single layer in the case of DLP (or other layer-by-layer) 3D printing. In contrast, the TTA-UC-based mechanism is anticipated to enhance spatial resolution given that scattered light and light transmitted through a layer can be tuned to fall below Iₜₕ where a superlinear relationship between rₚ and Iₑₓ exists.

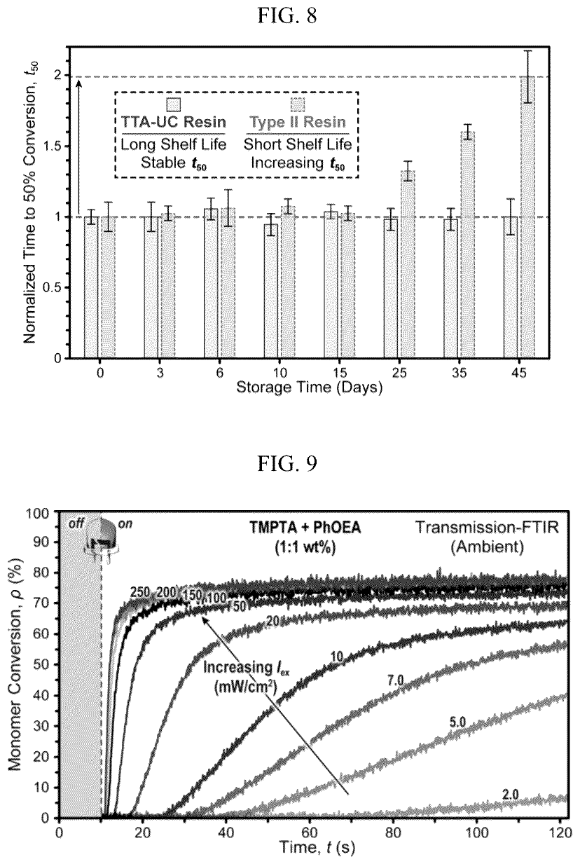

Relevant to the translation of photocurable resins from lab to market is their stability. To this end, a TTA-UC resin with the optimal formulation was prepared, stored under ambient conditions (i.e., room temperature, atmospheric air, and in the dark), and tested using RT-FTIR periodically over the course of 45 days (FIG. 8). Notably, little to no change in the photopolymerization kinetics and starting C═C absorption was observed, indicating excellent stability. In contrast, the analogous Type II resin containing PtOEP as the photoredox catalyst showed a steady increase in time to reach 50% conversion (t₅₀) over the same time frame, ultimately resulting in a 2× increase in t₅₀ after 45 days (FIG. 8). Furthermore, no discoloration was observed for TTA-UC resins upon irradiation, while those from Type II resins became visually darker. This observation was consistent with photobleaching profiles measured using in situ UV-V is absorption spectroscopy, where PtOEP absorbance in Type II resins rapidly decreased upon green light exposure. This result indicates that PS stability is better for TTA-UC to Type I initiation relative to Type II photoredox mechanisms. This is attributed to energy transfer from ³[PS]*, obviating the formation of highly reactive PS radical ions that occur during electron transfer and present a likely avenue to degradation for the case of Type II photoredox-initiated polymerizations. These results showcase the stability of visible-light-reactive resins that undergo TTA-UC to Type I photoinitiation, which will enable their long-term storage and use in 3D printing applications.

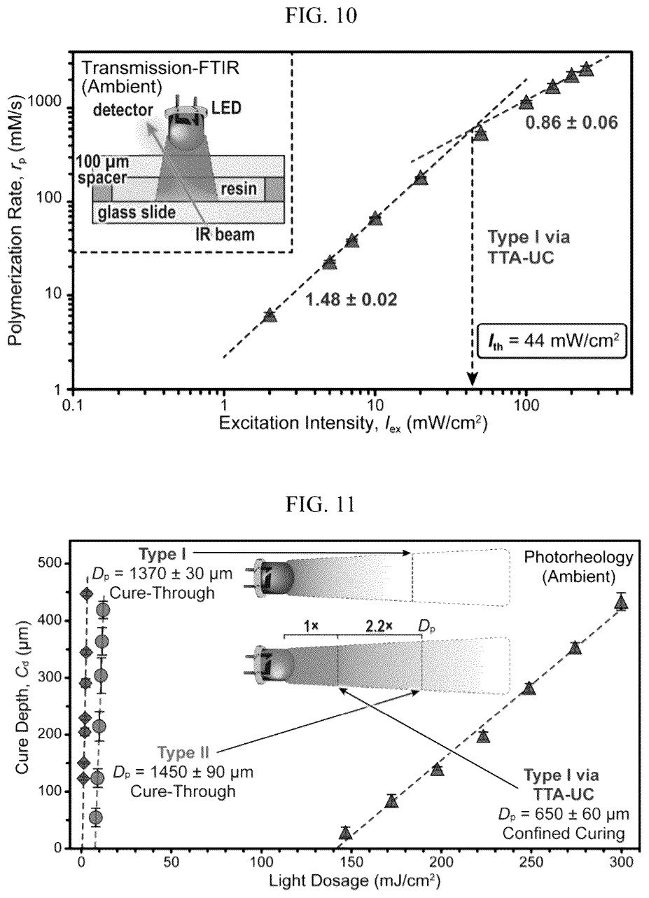

To make the TTA-UC resin compatible with DLP 3D printing, trimethylolpropane triacrylate (TMPTA) was incorporated as a cross-linker in a 1:1 weight ratio with 2-phenoxyethyl acrylate. Characterization of this resin was accomplished using transmission-mode RT-FTIR and photorheology for thin films (100 μm) under an ambient oxygen atmosphere to mimic layer curing in DLP 3D printing. Using the green LED with an Iₑₓ of 10 mW/cm², RT-FTIR of the crosslinkable resin formulation revealed a rₚ of 100±3.1 mM/s, which was within the same order of magnitude as the resin without cross-linker as measured using an ATR configuration, despite the presence of oxygen. Notably, polymerizations began shortly after turning the light on, with an average delay (tᵢₙₕ) of 4.0±0.5 s. This short inhibition period was presumed to arise from triplet quenching by oxygen, and it could be further reduced upon increasing Iₑₓ from 10 to 50 mW/cm². This was also supported by decreasing the concentration of BAPO, which led to lower polymerization rates but only a slight increase in tᵢₙₕ. Furthermore, characterizing rₚ for this system (100 μm thickness in ambient oxygen) at several different intensities revealed an Iₜₕ of ~44 mW/cm² (FIG. 9 and FIG. 10), which was an order or magnitude larger than that measured using ATR under inert atmospheric conditions (Iₜₕ=4 mW/cm²). Among the intensities measured, Iₑₓ=7 mW/cm² matched that used for 3D printing, which gave rₚ=48±1.3 mM/s and tᵢₙₕ=21±0.3 s. U sing these same conditions (Iₑₓ=7 mW/cm², thickness=100 μm), photorheology was used to estimate the minimum irradiation time required for curing (i.e., gel point), which was characterized by crossover of the storage (G′) and loss (G″) moduli. Under these conditions, the average gel point was 39.6±2.4 s, which is within a reasonable time frame for DLP 3D printing.

Expanding upon these initial photocuring results, a series of systematic photorheology experiments were performed to understand the influence of the photopolymerization mechanism (TTA-UC, Type I, and Type II) on vertical (z) overcure (FIG. 11). To this end, a series of cure depth (C_{d}) experiments going beyond a single desired 100 μm layer were performed, holding constant (to the best of our ability) key factors influencing C_{d} outside the photosystem composition and associated mechanism. Specifically, Iₑₓ from the 405 nm LED for Type I and 525 nm LED for Type II and TTA-UC was set to 0.1, 0.5, and 10 mW/cm², respectively, to provide similar rₚ values of ~220 mM/s, as measured using RT-FTIR. Furthermore, the 405 and 525 nm light-absorbing components (i.e., BAPO and PtOEP, respectively) provided resins with corresponding average LED transmittance values for a 100 μm path length of 78% and 79%, respectively, across the full wavelength range of spectral overlap (i.e., considering chromophore absorbance and LED emission). The C_{d} values were characterized as a function of light exposure time for each resin. After irradiation of the resin sitting in a 500 μm gap between static parallel plates, unreacted monomer was wicked away, and the upper plate was lowered stepwise (1 μm/s) until reaching a set force of 2 N, upon which the gap height was equated to C_{d} (FIG. 11). Next, intrinsic resin properties influencing C_{d} were determined using the Jacobs equation (Equation (3)):

$${C}_{d} = {D}_{p} ln ( \frac{{E}_{0}}{{E}_{c}} ) \qquad ( 3 )$$

where Dₚ corresponds to the penetration depth of light, E_{c} is the critical exposure energy required to cure an infinitesimal layer, and E₀ is the experimental exposure energy (i.e., light dosage).

Plotting C_{d} vs E₀ for each of the three resin formulations revealed a stark disparity in the light dosage required to cure a given depth (=slope) and the critical exposure E_{c} (=xintercept) for TTA-UC relative to the Type I and Type II controls (FIG. 11). Due to its lower quantum efficiency of initiation, TTA-UC-driven Type I has an E_{c} that is ~20× higher than that of the Type I and II systems. Importantly, however, despite the higher energy requirement for TTA-UC, its associated Dₚ of 650±60 μm is ~2× lower than for Type I (1370±30 μm) and Type II (1450±90 μm). Given the nearly matched optical densities for the 525 and 405 nm absorbing resins, one would anticipate equivalent Dₚ values of ~900 μm based on Equation 4:

$${D}_{p}^{predicted} = \frac{log ( 0.37 )}{- {ε}_{avg} \times [ PS ]} \qquad ( 4 )$$

where ε_{avg} is the average molar absorptivity based on the overlap between the green LED emission and PS or violet LED emission and I absorption profiles. However, this equation was created to correlate Dₚ to C_{d} for traditional free-radical polymerizations, where a sublinear relationship between Iₑₓ and photocuring exists. The considerably lower Dₚ for TTA-UC is hypothesized to arise from the superlinear relationship between Iₑₓ and rₚ. In turn, this should correspond with reduced vertical overcure (i.e., cure-through) from light transmitted beyond a single print layer while also providing a mechanism to reduce lateral overcure from scattered light. This form of photocuring confinement is distinct from traditional absorptive strategies, where opaquing agents (i.e., dyes that act as passive absorbers) are added to 3D printing resins to attenuate light. As such, improved resolution for layer-by-layer 3D printing relative to conventional one-photon curing processes is anticipated when using the TTA-UC to Type I resin.

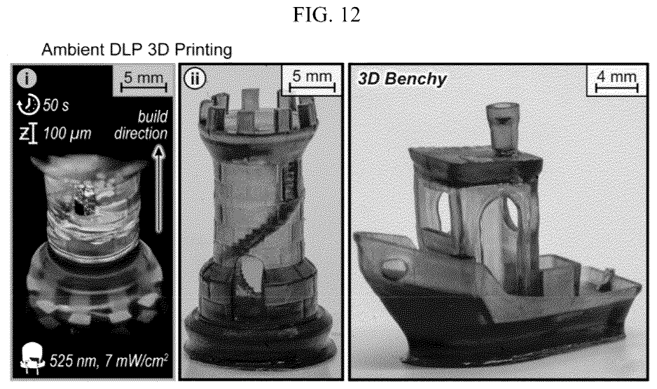

The TTA-UC photosystem was also employed for DLP 3D printing under conditions comparable to those used for the aforementioned characterization: a green LED having λₘₐₓ of 525 nm, full width at half-maximum (fwhm) of 34 nm, and maximum Iₑₓ of 7 mW/cm². Printing was performed under ambient conditions with no resin deoxygenation. A n initial print file containing 12 discrete sections with preprogrammed light exposure times from 5 to 115 s per 100 μm layer was used to determine the optimal exposure time. From this, it was found that a minimum exposure time of 45 s/100 μm layer could be used to fabricate objects with lateral (x, y) features as small as 100 μm, which corresponds to ~4-5 pixels on the projected image. Notably, there was little observable lateral overcure at exposure times >45 s, which may arise from the two-photon nature of the photocuring process. Using an exposure time of 50 s/100 μm (~7 mm/h), two complex prints containing several overhangs and small holes were targeted. Specifically, a Rook that contained an internal spiral staircase and a 3D Benchy with small (~4 mm diameter) portholes on the hull and a hollow smokestack were printed (FIG. 12). For the 3D Benchy, the entire print (1.0 cm³) took 3 h and 10 min to complete (build rate=0.32 cm³/h). This result is comparable to that previously reported for the same object produced while showing a qualitative improvement in feature resolution using the present method. Moreover, none of the TTA-UC to Type I prints required incorporation of photostable opaquing agents to achieve high-resolution features (i.e., mitigate overcure), which simplifies the resin formulation and paves an avenue to semitransparent and colorless objects with further optimization, such as lowering PS concentration and/or identifying bleachable PSs. These DLP 3D prints showcase the potential of TTA-UC to Type I photocuring as a new mechanism for rapid, low intensity, and high-resolution manufacturing.

Thus, the present inventors have discovered a Type I photocurable resin driven by TTA-UC with low-intensity (~10 mW/cm²) green light (~525 nm) that operates under an ambient oxygen atmosphere, which enabled rapid, high-resolution DLP 3D printing. This advance was facilitated by the high upconversion quantum efficiency (~15%) and low upconversion threshold (<50 mW/cm²) of the resin's PtOEP/DPA components. Optimization of the resin formulation using RT-FTIR spectroscopy under an inert argon atmosphere revealed that a 1:10:50 PtOEP:DPA:BAPO ratio, where [PtOEP]=600 μM, gave a rapid polymerization (~100 mM/s) at low light intensity (~10 mW/cm²). The polymerization rate of the TTA-UC to Type I system exhibited a quadratic dependence on light intensity. This feature can enable improved spatial resolution in 3D printing over that achievable with analogous Type I and II photosystems by mitigating curing that occurs outside of the desired irradiation zone from low-intensity transmitted and scattered light. Further supporting translation to 3D printing was excellent shelf stability of the TTA-UC resin, with no change in photopolymerization performance observed during a 45-day study.

The present inventors also explored similar photopolymerizations using a red LED (λₘₐₓ=625 nm) as the excitation source. For these experiments, Pd(II) meso-tetraphenyl Tetrabenzoporphine (PdTPBP) was used as the photosensitizer (1 equivalent, 0.05 mM). Three annihilators were tested: 9,10-bis((trimethylsilyl)ethynyl)anthracene (TMA-an), 9,10-bis((triethylsilyl)ethynyl)anthracene (TES-an), and 9,10-bis((triisopropylsilyl)ethynyl)anthracene (TIPS-an) at a concentration of 0.5 mM (10 equivalents). The Type I photoinitiator used was Ivocerin (200 equivalents, 10 mM). Triphenylphosphine (PPh₃) was used as an oxygen scavenger (200 equivalents, 10 mM). 2-Phenoxyethyl acrylate (PhOEA) and trimethylolpropane triacrylate (TMPTA) were used as monomer and crosslinker, respectively. In the red light system, the addition of an oxygen scavenger was needed to consume locally dissolved oxygen whereas in the prior green light system, DPA serves as both the annihilator and oxygen scavenger. The ethynyl linkages in the synthesized anthracene derivatives prohibit singlet oxygen scavenging, and thus no photopolymerization was observed under ambient conditions via FTIR. In the absence of DPA, an oxygen scavenger (e.g., phosphines, thiols, thioethers, alkenes) can be added to enable comparable oxygen tolerance and allow for photopolymerization to occur through the Type I via TTA mechanism with the more redshifted annihilators (i.e. lower energy) and allow for sensitization using other (e.g., longer) wavelengths of light in the presence of dissolved oxygen.

RT-FTIR was used to evaluate polymerization kinetics for resins with each of the three annihilators. Liquid resins were loaded between glass slides with 100 μm spacers. Irradiation with the 625 nm LED starts at 10 s. The TES-an annihilator was observed to provide the best solubility in various solvents and monomers. The resin containing TIPS-an as the annihilator exhibited the fastest polymerization rate and the lowest Iₜₕ value of 15.2 mW/cm², with TES-an and TMS-an having measured Iₜₕ values of 21.9 and 28.9 mW/cm², respectively (for example, compare to 44 mW/cm² in the green light system using DPA).

Thus, the present inventors have further demonstrated that the photocurable resin according to the present disclosure can be adapted to other wavelengths of excitation light.

This disclosure further encompasses the following aspects.

Aspect 1: A photocurable composition comprising: 0.0001 to 1 millimoles per liter of the photocurable composition of a photosensitizer capable of absorbing a first wavelength of light to form a first triplet state; 0.01 to 100 millimoles per liter of the photocurable composition of an annihilator compound capable of accepting triplet energy transfer from the first triplet state of the photosensitizer; 0.1 to 500 millimoles per liter of the photocurable composition of a photoinitiator capable of absorbing a second wavelength of light emitted from a singlet excited state of the annihilator compound; and a monomer composition; wherein the second wavelength of light has a wavelength that is less than the first wavelength of light; and wherein the photoinitiator does not absorb the first wavelength of light.

Aspect 2: The photocurable composition of aspect 1, wherein the photocurable composition further comprises 1 to 100 millimoles per liter of the photocurable composition of an oxygen scavenger, preferably wherein the oxygen scavenger comprises a phosphine, a thiol, an alkene, or a combination thereof.

Aspect 3: The photocurable composition of aspect 1 or 2, wherein a compound having a triplet energy state lower in energy than both the photosensitizer and the annihilator compound is excluded from the composition.

Aspect 4: The photocurable composition of any of aspects 1 to 3, wherein the photosensitizer comprises a metal porphyrin.

Aspect 5: The photocurable composition of any of aspects 1 to 3, wherein the photosensitizer comprises a platinum-containing porphyrin or phthalocyanine, preferably platinum octaethylporphyrin, platinum meso-tetraphenyl tetrabenzoporphine, platinum meso-tetraphenylporphine, platinum tetraphenyl tetranaphthoporphyrin, or platinum phthalocyanine; or a palladium-containing porphyrin or phthalocyanine, preferably a palladium meso-tetraphenyl tetrabenzoporphine, a palladium octaethylporphyrin, palladium meso-tetraphenylporphine, palladium tetraphenyl tetranaphthoporphyrin, palladium phthalocyanine, palladium octabutoxy phthalocyanine, or palladium octapentyl phthalocyanine; or a zinc-containing porphyrin or phthalocyanine, preferably a zinc octaethylporphyrin, zinc meso-tetraphenyl tetrabenzoporphine, zinc meso-tetraphenylporphine, zinc phthalocyanine, zinc octabutoxy phthalocyanine, or zinc octapentyl phthalocyanine; or a silicon-containing phthalocyanine, preferably a silicon octabutoxy phthalocyanine, or silicon octapentyl phthalocyanine; or 3,3′-carbonylbis(7-diethylaminocoumarin), 1,2,3,5-tetrakis(carbazol-9-yl)-4,6-dicyanobenzene, or 3,4,5,6-tetrakis(carbazol-9-yl)-1,2-dicyanobenzene; or a combination thereof.

Aspect 6: The photocurable composition of any of aspects 1 to 5, wherein the annihilator compound comprises a substituted or unsubstituted anthracene, a substituted or unsubstituted naphthalene, a substituted or unsubstituted pentacene, a substituted or unsubstituted pyrene, a substituted or unsubstituted perylene, a substituted or unsubstituted tetracene, a substituted or unsubstituted rubrene, or a combination thereof.

Aspect 7: The photocurable composition of any of aspects 1 to 6, wherein the photoinitiator comprises a Type I photoinitiator.

Aspect 8: The photocurable composition of any of aspects 1 to 7, wherein the photoinitiator forms free radicals upon absorption of the second wavelength of light.

Aspect 9: The photocurable composition of any of aspects 1 to 7, wherein the photoinitiator is a photoacid generator or a photobase generator.

Aspect 10: The photocurable composition of any of aspects 1 to 9, wherein the monomer composition comprises a free radically polymerizable monomer having ethylenic unsaturation, a cationically polymerizable monomer, an anionically polymerizable monomer, or a combination thereof.

Aspect 11: The photocurable composition of any of aspects 1 to 10, wherein the monomer composition comprises a free radically polymerizable monomer comprising a (meth)acrylate monomer, a (meth)acrylamide monomer, an alkenyl aromatic monomer, a vinyl monomer, or a combination thereof.

Aspect 12: The photocurable composition of any of aspects 1 to 11, wherein the monomer composition comprises a monomer comprising an epoxy functional group, an isocyanate functional group, an isothiocyanate group, a carbonate group, an ester group, a vinyl sulfone group, a hydroxyl group, a thiol group, an alkynyl group, or a combination thereof.

Aspect 13: The photocurable composition of any of aspects 1 to 12, wherein the monomer composition comprises a crosslinker.

Aspect 14: The photocurable composition of any of aspects 1 to 13, comprising 0.01 to 1 millimoles per liter, preferably 0.4 to 0.8 millimoles per liter of the photocurable composition of the photosensitizer; 1 to 10 millimoles per liter, preferably 4 to 8 millimoles per liter of the photocurable composition of the annihilator compound; and 20 to 40 millimoles per liter, preferably 25 to 35 millimoles per liter of the photocurable composition of the photoinitiator.

Aspect 15: The photocurable composition of aspect 14, wherein a molar ratio of the photosensitizer:annihilator compound:photoinitiator is 1:10:10 to 1:1,000:10,000.

Aspect 16: The photocurable composition of aspect 14 or 15, wherein the photosensitizer comprises a platinum-containing porphyrin, preferably platinum octaethylporphyrin; the annihilator compound comprises a substituted or unsubstituted diphenyl anthracene; and the photoinitiator comprises a bisacylaphosphine oxide, preferably phenylbis(2,4,6-trimethylbenzoyl)phosphine oxide.

Aspect 17: The photocurable composition of any of aspects 1 to 13, comprising 0.0001 to 1 millimoles per liter, preferably 0.04 to 0.06 millimoles per liter of the photocurable composition of the photosensitizer; 0.01 to 10 millimoles per liter, preferably 0.4 to 0.8 millimoles per liter of the photocurable composition of the annihilator compound; 0.1 to 500 millimoles per liter, preferably 5 to 15 millimoles per liter of the photocurable composition of the photoinitiator; and 1 to 100 millimoles per liter, preferably 5 to 15 millimoles per liter of the photocurable composition of an oxygen scavenger.

Aspect 18: The photocurable composition of aspect 17, wherein a molar ratio of the photosensitizer:annihilator compound:photoinitiator:oxygen scavenger is 1:10:1:10 to 1:1,000:10,000:10,000.

Aspect 19: The photocurable composition of aspect 17 or 18, wherein the photosensitizer comprises a palladium-containing porphyrin, preferably a palladium tetraphenylporphyrin; the annihilator compound comprises a substituted or unsubstituted diethynyl anthracene; the photoinitiator comprises a dialkyl germanium, preferably bis(4-methoxybenzoyl)diethylgermanium; and the oxygen scavenger comprises triphenylphosphine.

Aspect 20: A cured composition derived from the photocurable composition of any of aspects 1 to 19.

Aspect 21: A method of providing a cured composition, the method comprising: irradiating the photocurable composition of any of claims 1 to 19 with a first wavelength of light to provide the cured composition, wherein the first wavelength of light is capable of being absorbed by the photosensitizer, and wherein the photoinitiator does not absorb the first wavelength of light.

Aspect 22: The method of aspect 21, wherein the first wavelength of light is absorbed by the photosensitizer to provide a first triplet state; wherein the annihilator compound accepts triplet energy transfer from the first triplet state of the photosensitizer and emits a second wavelength of light; and wherein the second wavelength of light is absorbed by the photoinitiator to generate a reactive species capable of initiating polymerization of the monomer composition.

Aspect 23: The method of aspect 21 or 22, wherein the first wavelength of light is 400 to 1000 nm, preferably 450 to 750 nm.

Aspect 24: The method of any of aspects 21 to 22, wherein the method is conducted in the presence of oxygen.

Aspect 25: The method of any of aspects 21 to 24, wherein the first wavelength of light is at an intensity of less than 10 mW/cm².

Aspect 26: The method of any of aspects 21 to 25, wherein a gelation time of the photocurable composition is 60 seconds or less.

Aspect 27: The method of any of aspects 21 to 26, wherein the method is a three dimensional printing method, preferably a light-based additive manufacturing method, more preferably digital light processing, stereolithography, or computed axial lithography.

Aspect 28: The method of aspect 27, wherein the method is a light-based additive manufacturing method comprising: irradiating a first portion of the curable composition of any of aspects 1 or 19 with a first wavelength of light to provide a first layer comprising a polymer comprising repeating units derived from the monomer composition on a substrate; and forming at least one additional layer on the first layer by irradiating a second portion of the curable composition with the first wavelength of light to provide the at least one additional layer comprising a polymer comprising repeating units derived from the monomer composition to provide a three-dimensional object.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A photocurable composition comprising:
0.0001 to 1 millimoles per liter of the photocurable composition of a photosensitizer capable of absorbing a first wavelength of light to form a first triplet state;
0.01 to 100 millimoles per liter of the photocurable composition of an annihilator compound capable of accepting triplet energy transfer from the first triplet state of the photosensitizer;
0.1 to 500 millimoles per liter of the photocurable composition of a photoinitiator capable of absorbing a second wavelength of light emitted from a singlet excited state of the annihilator compound; and
a monomer composition;
wherein the second wavelength of light has a wavelength that is less than the first wavelength of light; and
wherein the photoinitiator does not absorb the first wavelength of light.

2. The photocurable composition of claim 1, wherein the photocurable composition further comprises 1 to 100 millimoles per liter of the photocurable composition of an oxygen scavenger.

3. The photocurable composition of claim 1, wherein a compound having a triplet energy state lower in energy than both the photosensitizer and the annihilator compound is excluded from the composition.

4. The photocurable composition of claim 1, wherein the photosensitizer comprises a metal porphyrin.

5. The photocurable composition of claim 1, wherein the photosensitizer comprises
a platinum-containing porphyrin or phthalocyanine; or
a palladium-containing porphyrin or phthalocyanine; or
a zinc-containing porphyrin or phthalocyanine; or
a silicon-containing phthalocyanine; or
3,3′-carbonylbis(7-diethylaminocoumarin), 1,2,3,5-tetrakis(carbazol-9-yl)-4,6-dicyanobenzene, or 3,4,5,6-tetrakis(carbazol-9-yl)-1,2-dicyanobenzene;
or a combination thereof.

6. The photocurable composition of claim 1, wherein the annihilator compound comprises a substituted or unsubstituted anthracene, a substituted or unsubstituted naphthalene, a substituted or unsubstituted pentacene, a substituted or unsubstituted pyrene, a substituted or unsubstituted perylene, a substituted or unsubstituted tetracene, a substituted or unsubstituted rubrene, or a combination thereof.

7. The photocurable composition of claim 1, wherein the photoinitiator comprises a Type I photoinitiator.

8. The photocurable composition of claim 1, wherein the photoinitiator forms free radicals upon absorption of the second wavelength of light or wherein the photoinitiator is a photoacid generator or a photobase generator.

9. The photocurable composition of claim 1, wherein the monomer composition comprises a free radically polymerizable monomer having ethylenic unsaturation, a cationically polymerizable monomer, an anionically polymerizable monomer, or a combination thereof.

10. The photocurable composition of claim 1, wherein the monomer composition comprises
a free radically polymerizable monomer comprising a (meth)acrylate monomer, a (meth)acrylamide monomer, an alkenyl aromatic monomer, a vinyl monomer, or a combination thereof; or
a monomer comprising an epoxy functional group, an isocyanate functional group, an isothiocyanate group, a carbonate group, an ester group, a vinyl sulfone group, a hydroxyl group, a thiol group, an alkynyl group, or a combination thereof.

11. The photocurable composition of claim 1, wherein the monomer composition comprises a crosslinker.

12. The photocurable composition of claim 1, comprising
0.01 to 1 millimoles per liter of the photocurable composition of the photosensitizer;
1 to 10 millimoles per liter of the photocurable composition of the annihilator compound; and
20 to 40 millimoles per liter of the photocurable composition of the photoinitiator;
wherein a molar ratio of the photosensitizer:annihilator compound:photoinitiator is 1:10:10 to 1:1,000:10,000; and
wherein
the photosensitizer comprises a platinum-containing porphyrin;
the annihilator compound comprises a substituted or unsubstituted diphenyl anthracene; and
the photoinitiator comprises a bisacylaphosphine oxide.

13. The photocurable composition of claim 1, comprising
0.0001 to 1 millimoles per liter of the photocurable composition of the photosensitizer;
0.01 to 10 millimoles per liter of the photocurable composition of the annihilator compound;
0.1 to 500 millimoles per liter of the photocurable composition of the photoinitiator; and
1 to 100 millimoles per liter of the photocurable composition of an oxygen scavenger;
wherein a molar ratio of the photosensitizer:annihilator compound:photoinitiator:oxygen scavenger is 1:10:1:10 to 1:1,000:10,000:10,000; and
wherein
the photosensitizer comprises a palladium-containing porphyrin;
the annihilator compound comprises a substituted or unsubstituted diethynyl anthracene;
the photoinitiator comprises a dialkyl germanium; and
the oxygen scavenger comprises triphenylphosphine.

14. A cured composition derived from the photocurable composition of claim 1.

15. A method of providing a cured composition, the method comprising:
irradiating the photocurable composition of claim 1 with a first wavelength of light to provide the cured composition,
wherein the first wavelength of light is capable of being absorbed by the photosensitizer, and wherein the photoinitiator does not absorb the first wavelength of light.

16. The method of claim 15,
wherein the first wavelength of light is absorbed by the photosensitizer to provide a first triplet state;
wherein the annihilator compound accepts triplet energy transfer from the first triplet state of the photosensitizer and emits a second wavelength of light; and
wherein the second wavelength of light is absorbed by the photoinitiator to generate a reactive species capable of initiating polymerization of the monomer composition.

17. The method of claim 15, wherein the first wavelength of light is 400 to 1000 nm and the first wavelength of light is at an intensity of less than 10 mW/cm².

18. The method of claim 15, wherein the method is conducted in the presence of oxygen.

19. The method of claim 15, wherein a gelation time of the photocurable composition is 60 seconds or less.

20. The method of claim 15, wherein the method is a light-based additive manufacturing method comprising:
irradiating a first portion of the curable composition of claim 1 with a first wavelength of light to provide a first layer comprising a polymer comprising repeating units derived from the monomer composition on a substrate; and
forming at least one additional layer on the first layer by irradiating a second portion of the curable composition with the first wavelength of light to provide the at least one additional layer comprising a polymer comprising repeating units derived from the monomer composition to provide a three-dimensional object.
